(19) United States
(12) Patent Application Publication
(10) Pub. No.: US 2015/0304331 A1
(43) Pub. Date: Oct. 22, 2015

(54) SERVICE PROVISION SYSTEM

(71) Applicant: INTEC INC., Toyama (JP)

(72) Inventors: Ikuo NAKAGAWA, Kanagawa (JP); Yoshifumi HASHIMOTO, Kanagawa (JP)

(73) Assignee: INTEC INC., Toyama-shi, Toyama (JP)

(21) Appl. No.: 14/648,151

(22) PCT Filed: Nov. 28, 2013
(86) PCT No.: PCT/JP2013/006987

§ 371 Date: May 28, 2015

(30) Foreign Application Priority Data
Nov. 30, 2012 (JP) 2012-263366

(51) Int. Cl. H04L 29/06; G06F 17/30

(52) U.S. Cl. CPC H04L 63/10; G06F 17/30539; H04L 63/0861

(57) ABSTRACT

A user is provided with a service based on the user's private information while the information is kept secret from any provider involved in the provision of the service. A service provider provides a service using a result of an analysis performed based on two or more information items with respect to stored data. Data received from a user device and stored by a server are data after a process has been performed by using a secret parameter of the user on at least respective parts of data input for these two or more information items. This process is defined such that performing the analysis based on the two or more information items on data stored on the server produces the same result as performing the analysis based on the two or more information items on data input in the user device.

### RELATED APPLICATIONS

This application claims the benefit of Japanese Patent Application No. 2012-263366 filed on Nov. 30, 2012 in Japan, the contents of which are incorporated herein by reference.

### TECHNICAL FIELD

The present invention relates to a system for providing a service based on private information of a user and, more particularly, to a technique that allows the service to be provided while protecting the private information.

### BACKGROUND ART

In recent years, provision of online services is becoming popular that handle information closely related to individual behavior and economic activities in the real world. For example, there have been appeared advertising models, SNS (Social Network Systems), or the like that utilize detailed geographic information and an action history of individuals as smartphones have become common, and they may use human relationship information shown in an outgoing/incoming call history, registration of friends, or the like, and location information acquired by GPS, RFID, or the like. Utilization of medical/genetic information, financial/asset information, or other highly sensitive information is also expected to come up for consideration in the future.

Services are also common that use cloud computing technologies to allow individuals, corporations, or other users to send their own data over networks to data centers or the like and store them there, not on their local devices. For example, M2M (Man to Machine) services are assumed to store data input from user devices in the cloud and perform statistical analyses or other processes on these data. Data to be stored in the cloud and processed like this may include private information described above.

Distribution of personal information unwanted or unintended by the individual largely affects society and requires delicate handling. However, information on individuals is essential for personalization of services, and placing too high a priority on privacy protection, resulting in such valuable information remaining untapped, causes opportunity loss. Technologies to balance utilization of private information with its protection are therefore being searched for.

One such example is a technique called Privacy-Preserving Data Mining (PPDM), which attempts to use security protocols and randomization to process data and find a helpful knowledge while protecting private information. PPDM is said to have four approaches: anonymization; utilization of a secure function; randomization; and encryption (see Non-Patent Document 1).

In the anonymization approach, a reliable third-party organization entrusted with all original data anonymizes them to diminish the discrimination of each record in such a way to preserve the effects of the data, and allows the anonymized data to be used by other people. For example, a technique called k-anonymity involves: concealing numbers, names, or other identifiers unique to individuals in the records; and generalizing values of age, gender, zip code, or other quasi-identifiers, which raise the possibility of identifying individuals when combined with one another, in such a way that for any combination of values of all the quasi-identifiers there are at least k records, in all the records, with those exact values of the quasi-identifiers (the larger k is, the stronger the protection will be). Even if k-anonymity alone can prevent records from being identified, a problem still remains as sensitive information in the records, attribute values, can be guessed. This is why a technique called I-diversity is used to generalize values in such a way that I types of sensitive attribute values exist in any record which belongs to the same group when anonymized (the larger I is, the stronger the protection will be).

The following three approaches are models where there is no reliable third-party organization, and are adopted when an agent A does not want to disclose its own database A to an agent B and the agent B does not want to disclose its own database B to the agent A, but they want to perform data mining and statistical processing on the united database A∪B and to know the result only.

In the secure function utilization approach, each of two or more agents separately holds its own data and, without disclosing the held data to others, allows others to acquire only data processing results, so that they can make calculations of functions, i.e. data mining and statistical processing, with the data secretly held by each agent being the input.

In the randomization approach, each agent adds noise with random numbers to its own original data, outputs the data from which the original data are difficult to be guessed, performs data mining and statistical processing on these data, and removes the effects of the noise from the results using statistical estimation.

In the encryption approach, each agent encrypts its own original data with homomorphic public key encryption, outputs the encrypted data, performs addition and multiplication among the encrypted data, and decrypts the results. The calculation can be made with the data remaining encrypted, hut feasible data mining and statistical processing are limited to addition, subtraction, and multiplication (see Patent Document 1).

### PRIOR ART DOCUMENTS

### Patent Document

Patent Document 1: Japanese Patent Laid-Open Application No. 2011-227193

### Non-Patent Document

Non-Patent Document 1: Jun Sakuma and Shigenobu Kobayasi, “Privacy-Preserving Data Mining,” Journal of the Japanese Society for Artificial Intelligence Vol. 24 No. 2 (2009)

### SUMMARY OF THE INVENTION

### Problems to be Solved by the Invention

Data mining in the recent field of so-called big data is intended to collect all data of all users and provide services from a variety of angles. For example, there may be a service that analyzes histories of past actions of all users (when, where, with whom, and how) and recommends suitable shops, directions, or the like in accordance with the relevant person's likes and tastes, or a service that analyzes histories of past purchases of all users and recommends suitable products or the like in accordance with the relevant person's likes and tastes. However, collecting all data increases a risk at the time of information leakage.

It is difficult to solve this problem of information leakage even with the above-described PPDM, and the calculation results are approximated by some PPDM approaches, which may decrease accuracy. In such cases, if original data are not stored as they are but stored after being processed for protection to prevent information leakage, even the user himself/herself cannot restore his/her own original data, which is another problem.

First, in the anonymization approach, which often involves just partially removing data (e.g. concealing the name, address, age, or other information), an adversary with a background knowledge about a certain individual might be able to combine it with other data or analyze the data in detail to identify the individual to whom the information belongs. Besides, the approach requires a third-party organization reliable enough to be entrusted with all original data, which is an entity almost impossible in the real world, and raising the level of anonymization so as to enhance the protection of private information would decrease the accuracy of data mining and statistical processing calculations, which is still another problem. In addition, erasing the original data in order to prevent information leakage would leave only the anonymized data, from which the original data cannot be restored.

The secure function utilization and randomization approaches do not require a reliable third-party organization but require each agent to hold its own original data, and therefore have a risk that data leakage from either agent leads to private information leakage.

Moreover, the secure function utilization approach can be applied to any calculation and provides exactly accurate results, but has a problem of being impractical as it requires extremely costly calculation when the number of pieces of input secret data is large as in data mining and statistical processing.

The randomization approach, on the other hand, does not require costly calculation but has a problem that it can only be applied to limited calculation and provides approximate calculation results. In addition, the randomization approach guarantees the protection of private information only statistically.

Lastly, the encryption approach has advantages in that it does not require a reliable third-party organization, provides accurate calculation results and, by holding encrypted data, allows those who have a key to restore the original data from the encrypted data. However, the approach has a problem that available calculation is limited to addition, subtraction, or multiplication, and the calculation is expensive and impractical because the calculation requires a large amount of exponentiation.

A purpose of the invention made in view of the above-mentioned problems is to provide, for example, a system in which original data input to a user device are stored in the cloud with private information being concealed and a third party (which may be a third party other than the above-described reliable organization) can make a calculation using these data with private information being concealed. This calculation preferably does not require a large cost as in the above case of using encryption yet can obtain an accurate calculation result. It is also desirable for the user himself/herself to be able to restore the original data from the data with private information being concealed.

### Means for Solving the Problems

The principle of the invention lies in, for example, focusing on a specific service which a provider on the cloud side wants to provide to a user and trying to solve the above-described problems concerning calculations for the specific service.

A service provision system of an example consistent with the principle of the invention comprises: a first server for being connected to a user device via a network and continuously receiving from the device and storing personal data of a user; and a second server for providing the user with a service based on data stored on the first server. The service is provided by using a result of an analysis based on two or more personal information items of the user. Data received from the device and stored by the first server are data after a process has been performed in the device by using a secret parameter of the user on at least respective parts of data input for the two or more information items. The process is defined such that performing the analysis based on the two or more information items on data stored on the first server produces a same result as performing the analysis based on the two or more information items on data input in the device, whereby the analysis is performed in the service provision system without the secret parameter being used.

### Advantages of the Invention

The invention practically allows, for example, a service based on a user's private information to be provided to the user with the information being hidden from any provider concerned with the provision of the service.

### BRIEF DESCRIPTION OF THE DRAWINGS

FIG. 1 illustrates an example of the application of a service provision method of an embodiment of the invention (hereinafter referred to as the present method);

FIG. 2 is a block diagram showing an example of the configuration of a user device and servers of providers for embodying the present method;

FIG. 3 illustrates a first concrete example of the service provision performed by the system shown in FIG. 2;

FIG. 4 is a flowchart showing an example of the operation of each entity in FIG. 2;

FIG. 5 is a block diagram showing another example of the configuration of a user device and servers of providers for embodying the present method;

FIG. 6 illustrates a first concrete example of the service provision performed by the system shown in FIG. 5;

FIG. 7 is a flowchart showing an example of the operation of each entity in FIG. 5;

FIG. 8 illustrates a second concrete example of the service provision performed by the system shown in FIG. 2;

FIG. 9 illustrates a third concrete example of the service provision performed by the system shown in FIG. 2;

FIG. 10 illustrates a second concrete example of the service provision performed by the system shown in FIG. 5;

FIG. 11 illustrates a first concrete example of the service provision performed by the system of FIG. 5 that is provided with a plurality of analysis providers' servers;

FIG. 12 illustrates a second concrete example of the service provision performed by the system of FIG. 5 that is provided with a plurality of analysis providers' servers;

FIG. 13 illustrates a third concrete example of the service provision performed by the system of FIG. 5 that is provided with a plurality of analysis providers' servers;

FIG. 14 illustrates a fourth concrete example of the service provision performed by the system of FIG. 5 that is provided with a plurality of analysis providers' servers;

FIG. 15 illustrates an example of a configuration for a third party to hold a parameter to be used in the present method;

FIG. 16 illustrates an example of the relationship between an analysis performed by a server of the analysis provider and a process (conversion) performed by a user device in the present method; and

FIG. 17 illustrates an example of characteristics of the present method as compared to conventional techniques.

### MODE OF EMBODYING THE INVENTION

In the configuration of the service provision system of an example consistent with the principle of the invention described above, data to be sent from the user device to the first server are processed in advance by using a secret parameter, so that data can be stored on the first server with private information being concealed, and therefore the risk of private information leakage can be extremely reduced even when information leaks from the server. Additionally, in the above-described configuration, the process performed by the user device is defined in such a way that, for a particular analysis for a service to be provided, the same calculation as performed on the original data can be performed on such data with private information being concealed, and accurate calculation results can be obtained without an enormous calculation cost unlike in the encryption. Collecting only data required for a particular service provision can also reduce the risk of information leakage.

In the above-described service provision system, the first server may comprise a unit that in response to a request from a user, sends stored personal data of the user, and the user may be able to restore the data input in the device by using the secret parameter to perform a process reverse to the process on data sent from the first server.

This allows data with private information being concealed to be acquired from the first server to restore original data as long as the user device holds the secret parameter without holding either the original data or the data with private information being concealed. When seen from the user, this means that the first server provides a storage service in which data corresponding to original data can be stored in a state where they cannot be deciphered by those other than the user. While a person who does not know the secret parameter cannot restore original data even if he/she acquires the data from the first server, the first server may conduct password authentication or the like in order to identify the requester as the user when sending data.

In the above-described service provision system, the first and second servers may be operated by providers different from each other, the analysis may be performed by a computer of the provider operating the first server, and the second server may receive a result of the analysis to provide a service using the result.

This configuration allows separation of a provider that stores and analyzes data of a user and a provider that provides the user with a service.

In the above-described configuration, information identifying a user to be provided with the service may be managed by a computer of the provider operating the second server, the computer comprising a unit that issues an ID to the user whose information is managed, the first server may receive the ID as well as personal data of the user, and data to be stored and analyzed and a result of the analysis may be managed according to the ID.

This allows information identifying the user (e.g. name, address, phone number, credit card information, etc.) to be managed by a provider that provides a service, and allows a provider that stores and analyzes data collected from the user device (e.g. history data of past actions of the user etc. with private information being concealed) to distinguish these data and analysis results by an ID associated with the user and not to have any involvement in who the user having the ID is. On the other hand, the service provider can be made to be able to identify who the user having the ID is, but not to be able to access the data on which an analysis result of the user is based, even though private information in the data is concealed. Charges for the service provision may be collected from the user by the service provider, which may distribute them to the storage and analysis providers.

In the above-described service provision system, data received from the device and stored by the first server may be data after an additional process has been performed in the device by using an additional parameter of the user on data for at least part of the information items processed by using the secret parameter, the service provision system may comprise a unit that receives the additional parameter used in the device for the purpose of the analysis, and the process and the additional process may be defined such that performing the analysis based on the two or more information items, including an additional analysis using the additional parameter, on data stored on the first server produces a same result as performing the analysis based on the two or more information items on data input in the device, whereby the analysis is performed in the service provision system without the secret parameter being used.

This configuration can prevent meaningful analysis results from being obtained from data with private information being concealed unless the additional parameter is acquired from the user, and can therefore achieve further improvement in security (securing).

In the above-described service provision system, data received from the device and stored by the first server may be data after an additional process has been performed in the device by using an additional parameter of the user on data for information items not processed by using the secret parameter, the service provision system may comprise a unit that receives the additional parameter used in the device for the purpose of the analysis, and the process and the additional process may be defined such that performing the analysis based on the two or more information items, including an additional analysis using the additional parameter, on data stored on the first server produces a same result as performing the analysis based on the two or more information items on data input in the device, whereby the analysis is performed in the service provision system without the secret parameter being used.

This configuration can prevent an additional meaning from being added to calculation results of the analysis of data with private information being concealed unless the additional parameter is acquired from the user, and therefore allows the obtained analysis results to be different (diversified) between one that cannot obtain the additional parameter (can obtain only the calculation results) and one that can obtain it (can obtain the calculation results and the additional meaning).

In the above-described two configurations, the first and second servers may be operated by providers different from each other, the analysis may be performed by a computer of the provider operating the second server, and the second server may receive data stored on the first server and the additional parameter used in the device to perform the analysis and provide a service using a result of the analysis.

This allows separation of a provider that stores data of a user and a provider that analyzes the stored data. If the analysis provider is allowed to obtain the additional parameter but others are not, even an adversary that makes calculations based on data stored by a storage provider but leaked therefrom could not obtain meaningful analysis results, particularly when the configuration allows securing, and therefore the risk of information leakage can be dispersed. When the configuration allows diversification, the risk can be dispersed to some extent since additional meanings of the calculation results cannot be obtained.

In the above-described two configurations, the service provision system may further comprise a third server for performing the analysis, the first, second, and third servers may be operated by providers different from one another, the third server may receive data stored on the first server and the additional parameter used in the device to perform the analysis, and the second server may receive a result of the analysis to provide a service using the result.

This allows separation of a provider that stores data of a user, a provider that analyzes the stored data, and a provider that provides a service to the user. The separation of the storage provider and the analysis provider allows the risk of information leakage to be dispersed as described above, and the separation of these providers and the service provider allows data collected from the user device to be separated from information identifying the user, also allowing the risk to be dispersed at the time of information leakage.

In the above-described configuration that allows diversification, the service may comprise: a first service that uses a result of an analysis based on the information items processed by using the secret parameter; and a second service that uses the result of the analysis and a result of an additional analysis based on the information items additionally processed by using the additional parameter, the service provision system may further comprise: a third server for performing an analysis for the first service; and a fourth server for performing an analysis for the second service, the third and fourth servers may be operated by providers different from each other, and the fourth server may comprise a unit that receives the additional parameter used in the device.

This allows separation of a first provider (the third server) that performs an analysis on stored data using a certain calculation result and a second provider (the fourth server) that performs a further analysis on the stored data using an additional meaning obtained from the certain calculation result. The risk at the time of information leakage can be reduced if the additional parameter is allowed to be obtained from the user only by an analysis provider reliable enough to be informed of this additional meaning.

Additionally, in this regard, each analysis provider can be made to acquire only limited information that it requires if the first analysis provider is only allowed to obtain data for information items required for a certain calculation from the first server (e.g. a storage provider other than the first and second analysis providers) and if the second analysis provider is allowed to obtain data for information items required for a certain calculation and the acquisition of the additional meaning from the first server. Such limited acquisition can also reduce the risk at the time of information leakage. The configuration in which the first analysis provider (the third server) and the second analysis provider (the fourth server) independently make certain calculations as above is easily adopted when a first service provider that uses analysis results produced by the first analysis provider and a second service provider that uses analysis results produced by the second analysis provider are different from each other.

On the other hand, there may be a configuration in which the first analysis provider (the third server) makes a certain calculation and the second analysis provider (the fourth server) receives the result of the certain calculation from the third server, receives from the first server (e.g. a storage provider other than the first and second analysis providers) data for information items required to acquire the additional meaning, and receives the additional parameter from the user to obtain the additional meaning of the certain calculation result and perform a further analysis. This can further limit the information to be acquired by the second analysis provider. This configuration is easily adopted when one service provider has a plurality of analysis providers share the analysis process in a serial manner.

In the above-described configuration that allows diversification, the service may comprise: a service that uses a result of a first analysis based on at least part of the two or more information items; and a service that uses a result of a second analysis based on another part of the two or more information items, and data for information items on which the first analysis is based may have been additionally processed by using a first additional parameter of the user, and data for information items on which the second analysis is based may have been additionally processed by using a second additional parameter of the user.

This can further diversify the analysis in that, in the analysis of data with private information being concealed, the first analysis can be performed by adding a first additional meaning to the calculation result if the first additional parameter is obtained from the user and the second analysis can be performed by adding a second additional meaning to the calculation result if the second additional parameter is obtained from the user.

In this configuration, the service provision system may further comprise: a third server for performing the first analysis; and a fourth server for performing the second analysis, the third and fourth servers may be operated by providers different from each other, the third server may receive data stored on the first server and the first additional parameter used in the device to perform the first analysis, and the fourth server may receive data stored on the first server and the second additional parameter used in the device to perform the second analysis.

This allows separation of a provider that performs the first analysis and a provider that performs the second analysis. Each analysis provider can then be made to acquire only limited information that it requires, in such a way that the first analysis provider obtains data for information items required for a certain calculation and the acquisition of the first additional meaning from the first server (e.g. a storage provider other than the first and second analysis providers) and the first additional parameter from the user, and the second analysis provider obtains data for information items required for a certain calculation and the acquisition of the second additional meaning from the first server and the second additional parameter from the user. Alternatively, the risk of information leakage can also be reduced only by having the first and second analysis providers obtain the same data from the first server and limiting the acquisition of the additional parameter to those that each analysis provider uses.

This configuration is easily adopted both when a first service provider that uses analysis results produced by the first analysis provider and a second service provider that uses analysis results produced by the second analysis provider are different from each other and when one service provider has a plurality of analysis providers share the analysis process in a parallel manner.

In the above-described configuration that allows diversification, the service may comprise: a service that uses a result of a first analysis performed on data, one of the two or more information items of which belongs to a first group; and a service that uses a result of a second analysis performed on data, one of the two or more information items of which belongs to a second group, and data on which the first analysis is to be performed may have been additionally processed by using a first additional parameter of the user, and data on which the second analysis is to be performed may have been additionally processed by using a second additional parameter of the user.

In the analysis of data with private information being concealed, this allows separation of a provider that performs the first analysis on data, a certain information item of which belongs to the first group and a provider that performs the second analysis on data, the same information item of which belongs to the second group. Then, the first analysis provider can perform an analysis with an additional meaning added within the scope of the first group by obtaining data that belong to the first group from the storage provider and the first additional parameter used for the data that belong to the first group from the user, and the second analysis provider can perform an analysis with an additional meaning added within the scope of the second group by obtaining data that belong to the second group from the storage provider and the second additional parameter used for the data that belong to the second group from the user. A detailed analysis can therefore be performed with the risk of information leakage being reduced.

In the above-described service provision system, the service may be provided to each of a plurality of users by using results of the analysis based on the two or more personal information items of each user and performed on the plurality of users.

This not only allows data collected from a device of a certain user to be used for the service provision to the user, but allows the service provision to each user to be defined based on data collected from devices of multiple users, and therefore can expand the range of the service to be provided.

The above-described service provision system may comprise a unit that assigns a secret unique value to the user, and the secret and additional parameters may be random numbers generated from the unique value in accordance with predetermined rules.

This is convenient because multiple secret and additional parameters for multiple information items can be automatically generated and used as long as the user remembers one secret unique value.

In the above-described service provision system, the device may acquire the secret and additional parameters, from a server outside the system that holds the secret and additional parameters for the user, to perform the process, and the service provision system may receive the additional parameter from the server outside the system.

This allows the secret and additional parameters to be saved on a server outside the system (e.g. a server of a reliable third-party organization) without having to store them in the user device, and allows the user to download the parameters therefrom to any device as required and perform the process for using the service.

In the above-described service provision system, the process to be performed in the user device can be defined, for example, in such a way that if the analysis includes any of the multiplication of x by y, the addition of x to y, the summation of the product of xᵢ and yᵢ over i (i represents natural numbers), and the distance between two points in an x-y coordinate system, where x and y are the two or more information items, then the process includes dividing x by α and multiplying y by α (α is the secret parameter), subtracting α from x and adding α to y (α is the secret parameter), dividing xᵢ by αᵢ and multiplying yᵢ by αᵢ (each αᵢ is the secret parameter), and shifting the x coordinate of each point by α and the y coordinate of each point by β (α and β are the secret parameters) and/or rotating the x and y coordinates of each point around a reference point through θ (θ is the secret parameter), respectively.

In the above-described configuration that allows securing, the additional process to be performed in the user device and the additional parameter can be defined, for example, in such a way that if the analysis includes any of the multiplication of x by y, the addition of x to y, the summation of the product of xᵢ and yᵢ over i (i represents natural numbers), and the distance between two points in an x-y coordinate system, where x and y are the two or more information items, then the additional process includes multiplying or dividing either one of x and y by γ (γ is the additional parameter), adding or subtracting γ to or from either one of x and y (γ is the additional parameter), multiplying or dividing either one of xᵢ and yᵢ by γᵢ (each γᵢ is the additional parameter), and multiplying the x and y coordinates of each point by γ (γ is the additional parameter), respectively.

In the above-described configuration that allows diversification, the additional process to be performed in the user device and the additional parameter can be defined, for example, in such a way that if the analysis includes the summation of the product of xᵢ and yᵢ over i (i represents natural numbers), or the distance between two points in an x-y coordinate system, where x and y are the two or more information items, then the additional process includes representing i or what each point means with an ID (information that allows details to be identified from the ID is the additional parameter).

The principle of the invention of the service provision system described above may off course also be realized by a method of the whole system, by a program for causing a general-purpose computer system to operate as the present system (or a storage medium in which the program is stored), by a product being any of the server for storing data, server for analyzing, and server for providing a service in the present system, and the user device connected to the present system, by a program for causing a general-purpose computer to operate as each server of the present system or the user device (or a storage medium in which the program is stored), or by a method performed by each server of the present system or the user device. Some of them are presented below.

A service provision method of an example consistent with the principle of the invention comprises: continuously sending personal data of a user from a user device to a server connected thereto via a network and allowing the data to be stored; performing, based on data stored on the server, an analysis based on two or more personal information items of the user; and using a result of the analysis to provide the user with a service. The device sends to the server data after a process has been performed by using a secret parameter of the user on at least respective parts of data input for the two or more information items, and the process is defined such that performing the analysis based on the two or more information items on data stored on the server produces a same result as performing the analysis based on the two or more information items on data input in the device, whereby the analysis is performed without the secret parameter being output from the device.

A program of an example consistent with the principle of the invention is for example a program to be installed by an analysis provider on its own computer, and causes a computer, capable of communicating with a storage server that stores personal data of a user continuously received form a user device via a network, to perform an analysis of the data for providing the user with a service based on the data. The analysis is based on two or more personal information items of the user, and the program causes the computer to comprise: a unit that acquires from the storage server data after a process has been performed by using a secret parameter of the user on at least respective parts of data input in the device for the two or more information items, as data received from the device and stored on the storage server; and a unit that performs without using the secret parameter the analysis on data acquired from the storage server. The process is defined such that performing the analysis based on the two or more information items on data stored on the storage server produces a same result as performing the analysis based on the two or more information items on data input in the device.

The above-described program may further cause the computer to comprise a unit that sends a result of the analysis to a service server for providing the service to the user whose information identifying an individual as a user to be provided with the service is managed, and the computer, not referring to the information identifying an individual but according to an ID issued to the user whose information is managed, may manage data acquired from the storage server and a result of the analysis to be sent to the service server.

Moreover, data acquired from the storage server are data after an additional process has been performed, in addition to the process, by using an additional parameter of the user on part of data input in the device for the two or more information items, and the unit that performs the analysis comprises a unit that acquires the additional parameter from the user and performs a process reverse to the additional process on data acquired from the storage server.

A program of an example consistent with the principle of the invention is for example a program to be installed on a computer to be a user device, and causes a computer, capable of being connected via a network to a system for continuously receiving from a user device and storing personal data of a user and providing the user with a service based on the data, to function as the device. The service is provided by using a result of an analysis based on two or more personal information items of the user, and the program causes the computer to comprise: a unit that holds a secret parameter of the user; a unit that uses the secret parameter to process at least respective parts of that personal data of the user input for the two or more information items; and a unit that sends the processed data to a server that performs the storing in the system. The process is defined such that performing the analysis based on the two or more information items on data stored on the server produces a same result as performing the analysis based on the two or more information items on data input in the device, whereby the analysis is performed in the system without the secret parameter being used

The above-described program may, for example, be downloaded to the user device when the user registers information identifying the user with the service provider and it issues an ID to the user. The above-described program may cause data on which the process is already performed as well as the ID to be sent to the server.

The above-described program may further cause the computer to comprise: a unit that requests the server to send stored personal data of the user; and a unit that restores the input data by using the secret parameter to perform a process reverse to the process on data sent in response to the request.

The above-described program may further cause the computer to comprise: a unit that holds an additional parameter of the user; a unit that uses the additional parameter to, in addition to or separately from the process, additionally process part of the personal data of the user input for the two or more information items, and allows the processed and additionally processed data to be data to be sent to the server; and a unit that chooses a server to use the additional parameter to perform the analysis from among a plurality of servers in the system, and sends the additional parameter to the server.

Now, a service provision method of embodiments of the invention (hereinafter referred to as the present method) will be described, by way of example, with reference to the drawings.

The present method, allowing private information in personal data of a user to be concealed and preventing those other than the user from accessing the original data, allows a third party to use the data with privacy being guarded to provide statistical processing and additional services. The present method also proposes a new model of data distribution among a user who owns original data, a cloud-based storage provider, an analysis provider, and a service provider.

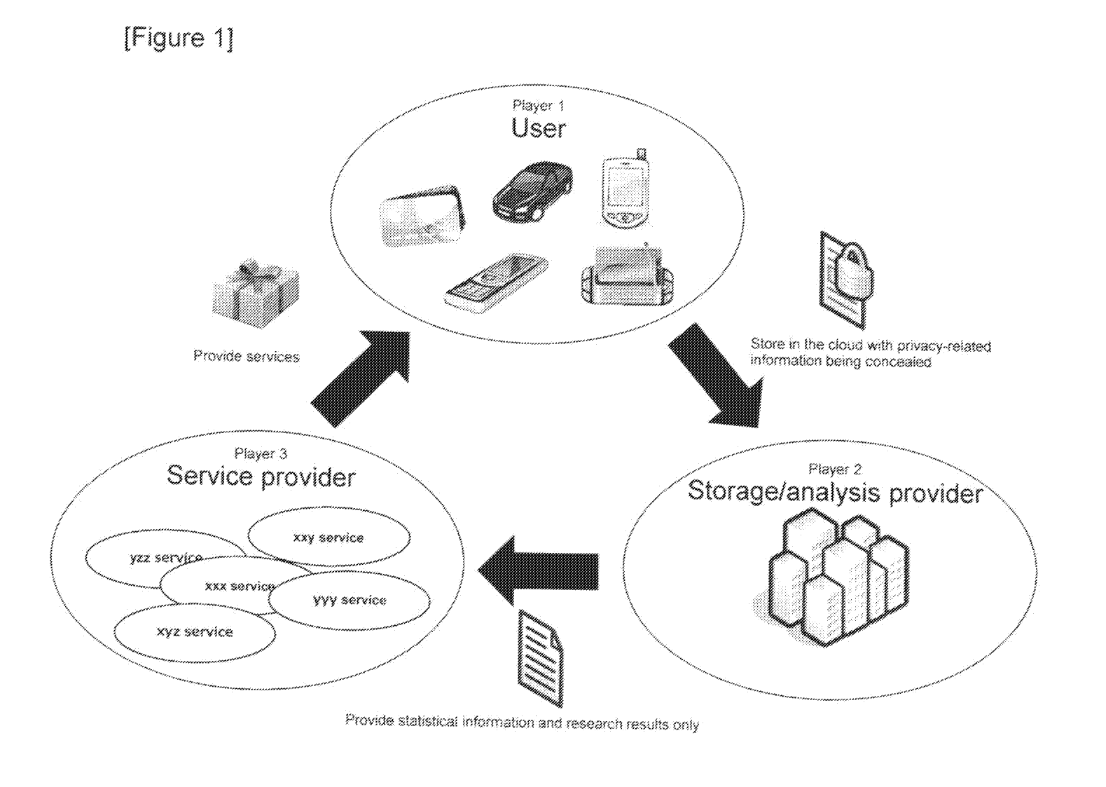

FIG. 1 shows an example of a data distribution model according to the present method. In this example, the distribution model comprises Players 1 to 3.

Player 1 is a user, who is also a user of a cloud-based data storage service in the present method. A device used by the user himself/herself has a function to collect personal data of the user and a function to communicate with another computer. Various devices can be used as this device, including a cellular phone, a smartphone, a personal computer, a television, an IC card, and an automobile.

Data collected by the user device are stored in the cloud, and therefore it is not required to store data on the user device. When data are stored in the cloud (uploaded from the user device), information on privacy is concealed by using a secret parameter to perform a predetermined conversion process.

The user himself/herself can restore the original data by getting the data processed with the conversion process and stored in the cloud and using the secret parameter to perform a conversion process reverse to the predetermined conversion process, if needed. This is why the conversion process that the user device performs before uploading data is sometimes called a reversible function. This conversion process may be performed by using an access parameter in addition to the secret parameter, and the accuracy of information to be handled can be varied by using different access parameters.

Player 2 is a storage/analysis provider that provides a cloud-based data storage service and analyzes stored data. The distribution model may be one in which the storage and analysis are performed not by the same provider but by different providers, so that there are a storage provider (Player 2-1) and an analysis provider (Player 2-2), separately.

Since data stored and analyzed by Player 2 are processed in advance with the above-described conversion process and the original data cannot be restored unless the secret parameter is known, the risk of information leakage is reduced. However, a certain analysis is allowed to be performed on the data processed with the conversion process. Moreover, an analysis result added with a certain meaning can be obtained by using an access parameter.

Player 3 is a service provider that provides the user with a service. An analysis provider provides a service provider with statistical information, research results, or the like as the result of analysis, and the service provider uses this to provide a value-added service. One service provider may provide a plurality of services, or separate service providers may provide each service. If there are a plurality of service providers, a plurality of analysis providers may be allowed to exist and separately analyze for services of their own corresponding service providers.

Since private information in data stored in the cloud is concealed, a distribution model in which there are only two players, namely a storage/analysis/service provider and a user, where a service provider itself stores and analyzes data would also reduce the risk of information leakage. Such a distribution model is therefore also included in embodiments of the invention.

In the example in FIG. 1, however, the storage/analysis providers (Player 2) and the service provider (Player 3) are separate providers, and the service provider receives only analysis results from the analysis provider and is not to access data stored by the storage provider. Separating providers in this way is useful for minimizing damage when the secret parameter has become known to or been guessed by an adversary, resulting in original data being able to be restored from data stored in the cloud.

For example, if the service provider is to store information identifying the user (e.g. name, address, phone number, credit card number, etc. of the user) in order to provide the user with a service and the storage/analysis provider is only to identify the user by an ID given by the service provider to the user and not to access information identifying the user, the information identifying the user stored by the service provider is protected even if stored data leak from the storage/analysis provider, and therefore it is not able to determine which user the leaked data belong to.

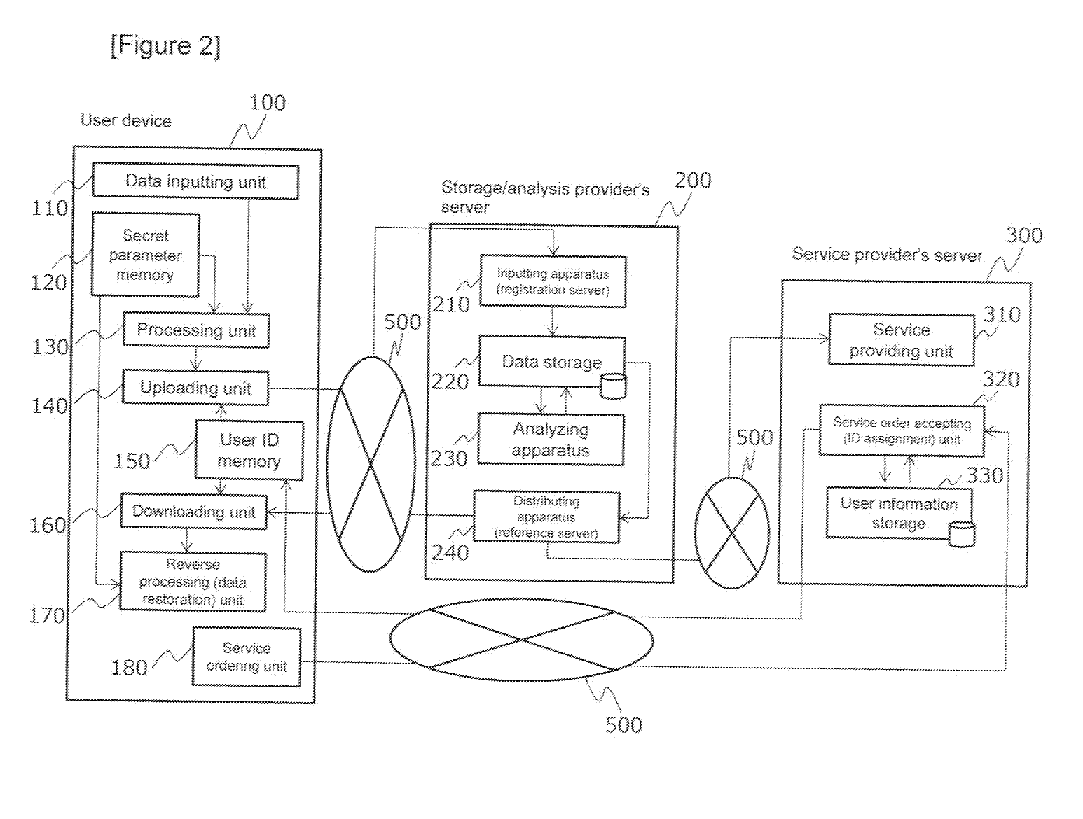

FIG. 2 shows an example of the configuration of a user device 100, a storage/analysis provider's server 200, and a service provider's server 300 for embodying the present method. The user device 100, the storage/analysis provider's server 200, and the service provider's server 300 can be connected to one another by a network 500. There may be different communication networks (e.g. wireless and wired networks, etc.) among them, or one communication network (e.g. the Internet) may connect them all.

The user device 100 comprises, for example, a device having computing functions on which a program for the present method is installed. Units for holding a secret parameter and for performing the process/reverse process may be provided in a hardware or software secure module.

The storage/analysis provider's server 200 comprises, for example, a server or server group of a data center or the like running cloud-based services on which a program for the present method is installed. The service provider's server 300 may comprise, for example, a general-purpose server or server group on which a program for the present method is installed.

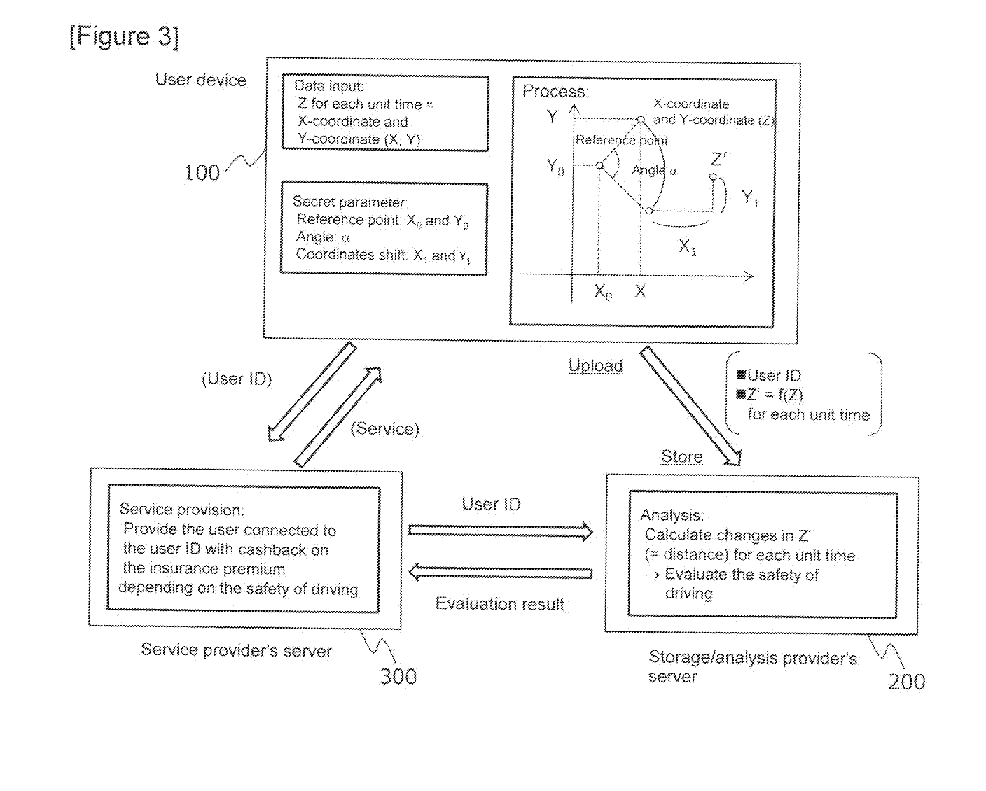

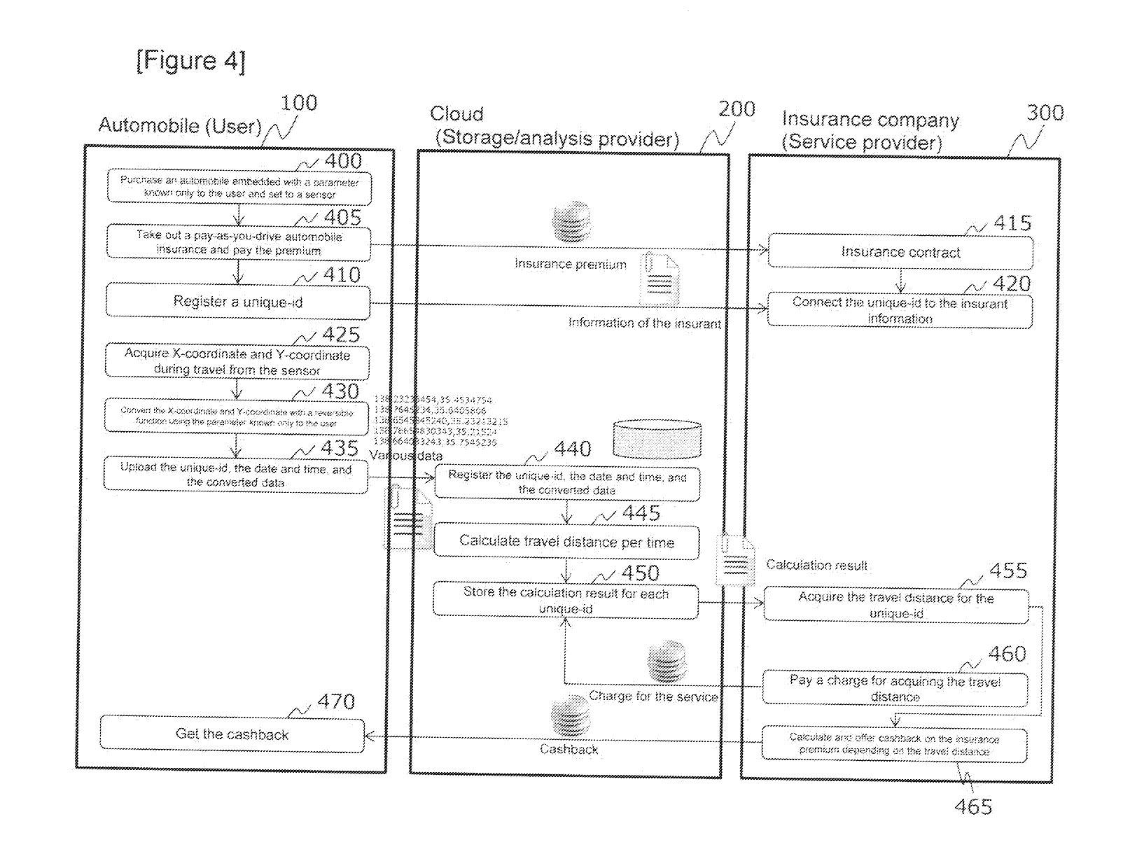

Functions of each unit in FIG. 2 will be described in accordance with a first concrete example of the service provision shown in FIG. 3, as well as with reference to an example of the operation flow shown in FIG. 4. Functions of each unit can be realized by hardware, software, or a combination of hardware and software.

FIG. 3 is an example in which the present method is applied to a service called “pay as you drive.” “Pay as you drive” means a “fee based on travel distance” and, in the automobile insurance industry, means to pay an insurance premium just for the amount of driving. Specifically, it is a system in which, for example, a required minimum basic insurance premium for a year is paid at once in advance and a metered insurance premium based on the travel distance or other travel data is calculated in accordance with the actual risk and is paid monthly using electronic withdrawal.

Recently in the United States, GMAC LLC has been offering a service since 2004, for vehicles equipped with a GM group-authorized optional in-vehicle device, that involves sending the travel distance as travel data and discounting the insurance premium as the annual travel distance gets shorter. For example, the insurance premium is discounted 28% if the annual travel distance is less than 7500 miles, and the discount rate is 33% for less than 5000 miles and as much as 40% for less than 2500 miles. On the other hand, the discount rate is 0% if the travel distance is 15000 miles or more.

In Britain, Norwich Union has set a risk-based detailed insurance premium since 2006, which involves sending the travel distance, travel time period, and traveling location as travel data from its own uniquely developed in-vehicle device. For example, the insurance premium for traveling an expressway at 70 mph is set at about one tenth of that for traveling a street at 30 mph. A surcharge of one pound per mile is set for young people aged 18 to 23 for traveling during a time period from 11 p.m. to 6 a.m., and the insurance premium gets lower if they avoid this time period.

In Japan, Aioi Insurance Co., Ltd has been running a service since 2004, for vehicles equipped with a Toyota Motor Corporation-authorized optional in-vehicle device, that involves sending the monthly travel distance from the in-vehicle device to the insurance company and collecting an amount to which a discount is applied in accordance with the travel distance. For example, a discount of about 15% is applied when the monthly travel is only 200 km compared to when it is 700 km.

Since data required for these services include information on the individual privacy of the user, there is a problem of the risk of data leakage due to the service provider holding data. The present method is thus applied as follows.

First a data inputting unit 110 of the user device 100 inputs map locations (X-coordinate and Y-coordinate) every unit time as sensor information during travel (425 in FIG. 4) A secret parameter memory 120 of the user device 100 holds “reference point: X₀ and Y₀,” “angle: α,” and “travel distance: X₁ and Y₁” as secret parameters known only to the user.

A processing unit 130 of the user device 100 performs a process f on an input map location Z (X-coordinate and Y-coordinate), in which it uses the secret parameters to rotate the location clockwise around the reference point through the angle and moves it by the travel distance (see FIG. 3), to obtain Z′ (430 in FIG. 4). A user ID memory 150 of the user device 100 holds a user ID (unique-id in FIG. 4) given by the service provider.

An uploading unit 140 of the user device 100 uploads processed data (Z′=f(Z) for each unit time here) and the user ID to an inputting apparatus (registration server) 210 of the storage/analysis provider's server 200 and has a data storage 220 store them (435 and 440 in FIG. 4) at an appropriate point in time (e.g. at the end of travel, at the end of the day, when the communications function turns on, etc.). The date and time may also be uploaded to show which date's travel data Z′ to be uploaded are for.

An analyzing apparatus 230 of the storage/analysis provider's server 200 specifies the user ID of a user to be analyzed to access the data storage 220 and acquires data of the user (e.g. a series of Z′ for a month) at an appropriate point in time (e.g. at the end of each month, at times determined so as to temporally distribute the load of the analyzing apparatus, etc.). The analyzing apparatus 230 then calculates the distance between neighboring Z's and accumulates the calculated distance to obtain the travel distance per time (e.g. one month) (445 in FIG. 4), and stores it in the data storage 220 with the corresponding user ID (450 in FIG. 4).

In this regard, since Z′ is a point obtained by the process in which point Z in the X-Y coordinate system is rotated around the reference point through the angle and added with a travel distance, the distance between points Z′ᵢ and Z′ᵢ₊₁ is equal to the distance between points Zᵢ and Zᵢ₊₁. Therefore, while the analyzing apparatus 230 cannot obtain information on the travel location Z that is related to the user's privacy, it can obtain information on the distance between two points required to provide a service by calculating from Z′. In short, while the conversion process f hides the original data Z, the calculation formula of the conversion process is predetermined in accordance with details of the analysis in such a way that Z′ satisfies the same purpose as Z for calculations required for the analysis.

A service providing unit 310 of the service provider's server 300 specifies the user ID of a user to be provided with the service to access the data storage 220 via a distributing apparatus (reference server) 240 of the storage/analysis provider's server 200, and acquires information on the user's travel distance of that month as an evaluation result made by the analysis provider (455 in FIG. 4) at an appropriate point in time (e.g. when details of a service to be provided are determined, etc.).

In this regard, the distributing apparatus 240 of the storage/analysis provider's server 200 in response to a query from the service provider's server 300 does not allow it to acquire data stored in the data storage 220 (a series of Z′ with the date and time in the example above) but allows it to acquire only the evaluation result (the travel distance of that month in the example above). The service provider may pay a charge for the provided evaluation result to the storage/analysis provider (460 in FIG. 4).

Based on an acquired evaluation result, the service providing unit 310 of the service provider's server 300 provides the user connected to the user ID with, for example, a service such as cashback on the insurance premium depending on the safety of driving (465 in FIG. 4). In a case where the safety rank is determined to be A when the monthly travel distance is less than 200 km, B when less than 500 km, C when less than 800 km, and so on, the service providing unit 310 may determine the rank based on the travel distance acquired from the storage/analysis provider's server 200, or the analyzing apparatus 230 may determine the rank as well and send the rank information to the service provider's server 300 as the evaluation result.

The user gets cashback or other services in the example above (470 in FIG. 4), but the service provided by the service provider's server 300 may be given outside the configuration shown in FIG. 2, for example, to the user's bank account or the like. As another example, the service providing unit 310 may provide a service by communicating with the user device 100 (automobile in the example above) or another device used by the user (e.g. smartphone) via the network 500. In this case, the user may send the user ID to the service provider's server 300 to request a service to be provided, and the service providing unit 310 may provide the service after password confirmation of the user ID or the like.

A downloading unit 160 of the user device 100 can send a user ID read from the user ID memory 150 to the storage/analysis provider's server 200 to download the user's own data stored in the data storage 220 (a series of Z with the date and time in the example above). The distributing apparatus 240 of the storage/analysis provider's server 200 then desirably confirms by password or the like whether the person who has sent the request is really the user connected to the user ID or not. This password confirmation may be realized by allowing the storage/analysis provider to share the above-described password to be confirmed by the service provider's server 300.

A reverse processing (data restoration) unit 170 of the user device 100 can restore an original location Z by performing a reverse process using a parameter stored in the secret parameter memory 120 on (moving by −X₁ in the X-axis direction and by −Y₁ in the Y-axis direction, and then rotating counterclockwise around the reference point (X₀, Y₀) through the angle α) downloaded data Z′. This download and data restoration may also be done by another device (e.g. a personal computer) being used by the user instead of the user device 100 itself.

As described above, the user is allowed to use an application that uses even important private information (e.g. makes a diary with a traveling route marked on a map) by downloading data stored in the cloud (a series of Z′ with the date and time in the example above) and restoring the original data (the location Z). From the viewpoint of the user, the application of the present method therefore seemingly allows a service offering a discount on an automobile insurance premium to be collaterally provided in addition to a service by which the user can safely save data including the user's own private information in the cloud.

A user of the present method can use the method in such a way that after processing and uploading input data by the user device 100 the user deletes the original data and, when the user runs an application that requires the data, the user downloads the data to a device equipped with the application (which does not have to be the device 100 to which the original data was input), runs the application, and deletes the data again after finishing the application. The user can thus enjoy both advantages, i.e., security against the loss or theft of data, and convenience. In addition to this, the user can get a separate and particular service from the service provider while protecting the privacy.

The user device 100 may comprise a service ordering unit 180 in order for a valid user ID to be stored in the user ID memory 150 in response to an application for a service (410 in FIG. 4), and the service ordering unit 180 may communicate with the service provider's server 300 via the network 500.

In the example above, the user sends an application to buy an automobile insurance to a service order accepting (ID assignment) unit 320 of the service provider's server 300 (405 and 415 in FIG. 4), and a user information storage 330 of the service provider's server 300 stores information of the user (the insurant in this case) in association with the user ID (420 in FIG. 4) and manages it securely. The user ID may be embedded in the device 100 in advance and associated with user information given to the service provider at the time of application (e.g. name, address, age, phone number, type of license, contract detail, etc., including information identifying the user), or the user ID may be assigned by the service provider at the time of application and sent to the device 100 to be stored.

The secret parameter in the user device 100 may be embedded in the purchased device 100 in advance without even the user knowing its value (400 in FIG. 4), or may be input to and stored on the device 100 with a value determined by the user himself/herself before the start of the service.

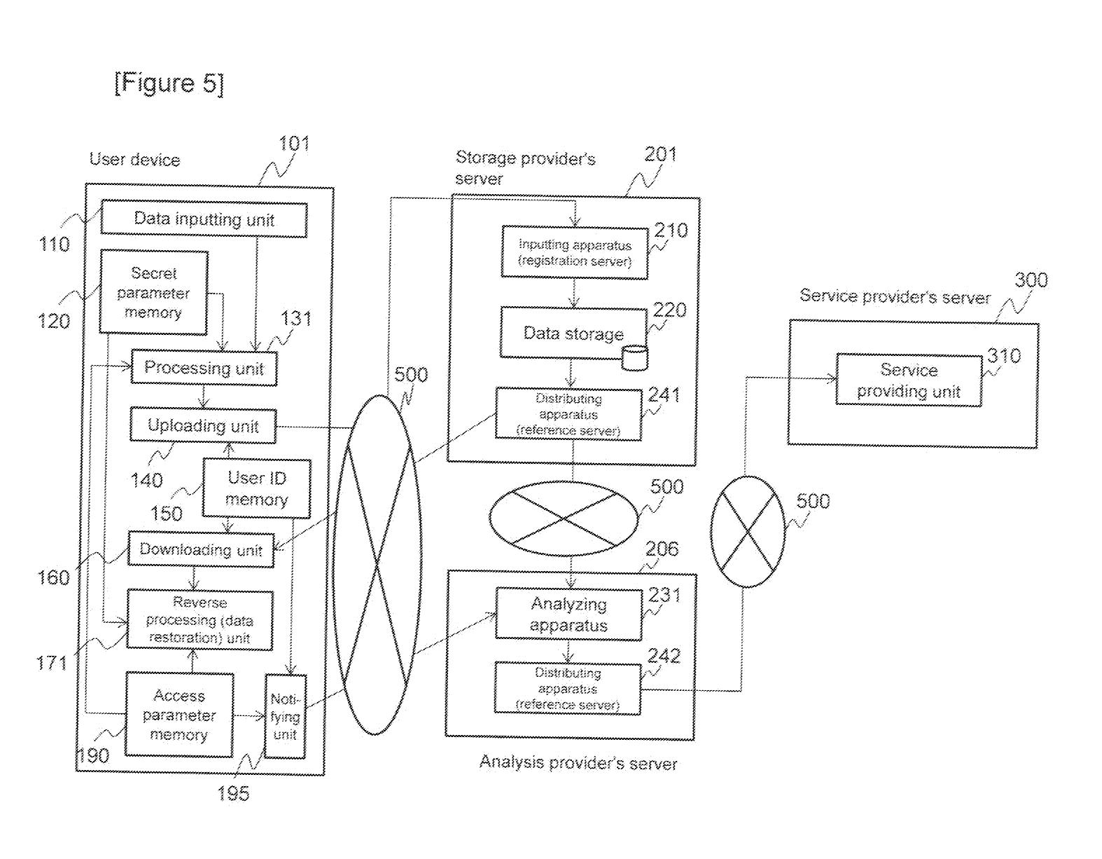

FIG. 5 shows an example of the configuration of a user device 101, a storage provider's server 201, an analysis provider's server 206, and the service provider's server 300 for embodying the present method. As compared to FIG. 2, this configuration differs in that the storage/analysis provider's server 200 is separated into the storage provider's server and the analysis provider's server and the network 500 is placed therebetween, but the various configurations described with FIG. 2 can also be applied to FIG. 5 except for the difference associated with the above. Illustrations are omitted as to parts for applying for a service, storing user information, and registering a user ID between the user device and the service provider's server.

The user device 101 in FIG. 5 is the same as the user device 100 in FIG. 2 except that an access parameter memory 190 is introduced, that a processing unit 131 and a reverse processing (data restoration) unit 171 accordingly use an access parameter, and that a notifying unit 195 for notifying an access parameter to the analysis provider in need of it is added.

The storage provider's server 201 in FIG. 5 may comprise, for example, a server or server group of a data center or the like running cloud-based services almost as it is. The analysis provider's server 206 may comprise, for example, a general-purpose server or server group on which a program for the present method is installed.

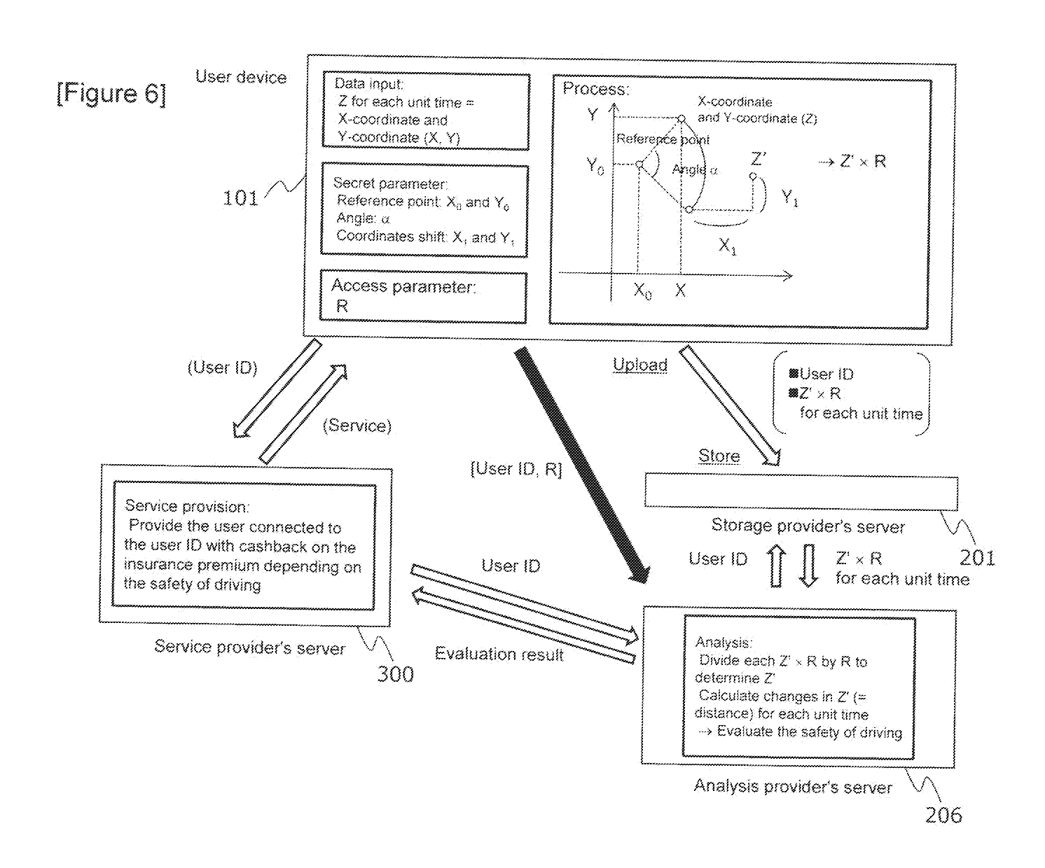

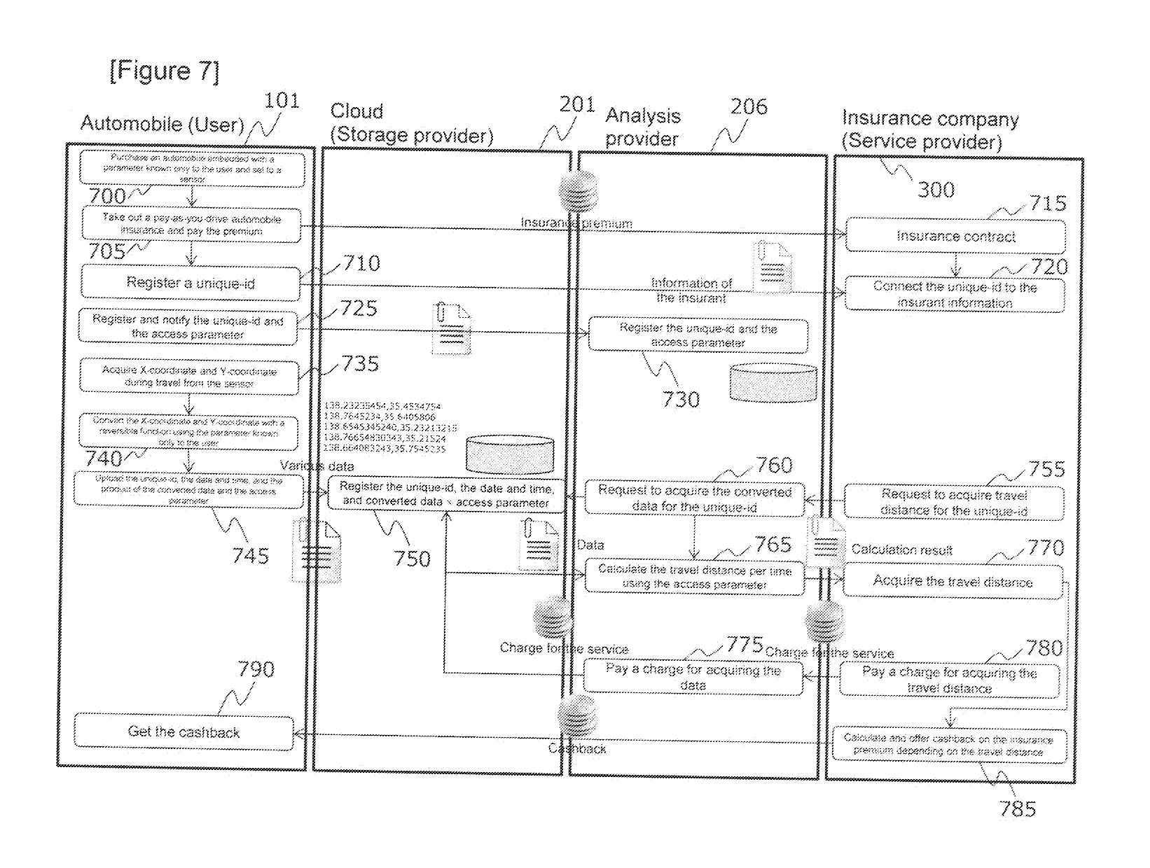

Functions of each unit in FIG. 5 will be described in accordance with a first concrete example of the service provision shown in FIG. 6 (an example of application to a “pay as you drive” service), as well as with reference to an example of the operation flow shown in FIG. 7.

First, the data inputting unit 110 of the user device 101 inputs map locations (X-coordinate and Y-coordinate) every unit time as sensor information during travel (735 in FIG. 7). The secret parameter memory 120 of the user device 101 holds “reference point: X₀ and Y₀,” “angle: α,” and “travel distance: X₁ and Y₁” as secret parameters known only to the user.

A processing unit 131 of the user device 101 performs the process f on an input map location Z (X-coordinate and Y-coordinate), in which it uses the secret parameters to rotate the location clockwise around the reference point through the angle and moves it by the travel distance (see FIG. 3), to obtain Z′ (740 in FIG. 7). An arbitrary numerical value R chosen in advance for a “pay as you drive” service is read from the access parameter memory 190, and is multiplied by Z′.

The user ID memory 150 of the user device 101 holds a user ID (unique-id in FIG. 7) given by the service provider, and the uploading unit 140 uploads processed data (Z′×R for each unit time here) and the user ID to the inputting apparatus (registration server) 210 of the storage provider's server 206 and has the data storage 220 store them (745 and 750 in FIG. 7) at an appropriate point in time. The date and time may also be uploaded to show which date's travel data Z′×R to be uploaded are for.

At a time when an evaluation result is required for providing a service and via a distributing apparatus (reference server) 242 of the analysis provider's server 206, the service providing unit 310 of the service provider's server 300 specifies the user ID of the user to be provided with the service and requests an analyzing apparatus 231 to perform an evaluation (755 in FIG. 7).

At a time according to the request from the service provider and via a distributing apparatus (reference server) 241 of the storage provider's server 201, the analyzing apparatus 231 of the analysis provider's server 206 specifies the user ID of the user to be analyzed and accesses the data storage 220 (760 in FIG. 7) to acquire data of the user (e.g. a series of Z′×R for a month).

The analyzing apparatus 231 of the analysis provider's server 206, for example, has received the user ID and the value of an access parameter R before the start of the service from the user registered as a user of the service and has registered them (725 and 730 in FIG. 7). Upon acquiring data of the user stored in the data storage 220, the analyzing apparatus 231 divides each Z′×R by R to determine each Z′. The analyzing apparatus 231 then calculates the distance between neighboring Z's and accumulates the calculated distance to obtain the travel distance per time (e.g. one month) (765 in FIG. 7).

The analyzing apparatus 231 of the analysis provider's server 206, via the distributing apparatus 242, causes the service providing unit 301 of the service provider's server 300 to acquire information on the user's travel distance of that month as an evaluation result for the requested user ID (770 in FIG. 7). The analysis provider's server 206 desirably deletes all the user's data acquired from the data storage 220 when it completes the calculation of the travel distance, and deletes all the calculation and analysis results when it completes the transmission of the evaluation result to the service provider.

The service provider may pay a charge for the provided evaluation result to the analysis provider (780 in FIG. 7), and the analysis provider may pay part of the charge, received from the service provider, for the provided data to the storage provider (775 in FIG. 7).

In this regard, since Z′ is a point obtained by the process in which point Z in the X-Y coordinate system is rotated around the reference point through the angle and added with a travel distance, the distance between points Z′ᵢ and Z′ᵢ₊₁ is equal to the distance between points Zᵢ and Zᵢ₊₁. Therefore, while the analyzing apparatus 231 cannot obtain information on the travel location Z that is related to the user's privacy, it can obtain information on the distance between two points required to provide a service by calculating from Z′. This means that if Z′ is left stored on the storage provider's server and if the data on the storage provider leak, the calculation for a particular analysis (calculation of the distance) itself can be performed though private information (location Z) is protected.

For this reason, in the configuration in FIG. 5, data to be stored on the storage provider's server are Z′ multiplied by R, and those who do not know the access parameter R cannot calculate the travel distance from the stored data. The storage provider and the analysis provider are separated, and only the analysis provider is allowed to know the access parameter R. The analysis provider can calculate the travel distance by canceling the coefficient R from the stored data, and those who can analyze the safety of driving can be limited to the analysis provider.

The downloading unit 160 of the user device 101 can send a user ID read from the user ID memory 150 to the storage provider's server 201 to download the user's own data stored in the date storage 220 (a series of Z′×R with the date and time in the example above).

A reverse processing unit 171 of the user device 101 or another device being used by the user can then restore an original data (location Z) by dividing downloaded data Z′×R by R stored in the access parameter memory 190 to obtain Z′ and performing a reverse process using a secret parameter on this Z′.

Such type of the present method that uses an access parameter has various advantages and, particularly in the configuration in FIG. 5, offers an advantage of dispersing the risk of data leakage by separating the storage provider and the analysis provider. That is, the use of an access parameter prevents the calculation itself for analysis from being made from data stored by the storage provider, and allows the analysis provider to perform an analysis only when if acquires data from the storage provider as needed and uses an access parameter.

In that regard, if responsibilities are clearly separated between the storage provider that only performs storage and the analysis provider that only performs analysis by preventing the analysis provider from storing acquired data and an analysis result not just private information but also data allowing a particular analysis can be prevented from being stored in the cloud, and the risk of data leakage can be further reduced.

The present method in the examples of “pay as you drive” services described above (FIG. 2 or FIG. 5) allows data to be securely managed by using the cloud. In other words, since the user uploads the user ID and Z′ as data that are meaningless when they leak to the outside, it is difficult to identify the user and the privacy is protected. Since information itself managed by the storage/analysis provider is data that are meaningless when they leak to the outside, the burden on those who manage data in case of leakage can be reduced. Moreover, the algorithm of the process for the conversion to meaningless data allows for fast calculation, so that the transmission of results calculated on an automobile is also practical.

Moreover, since data can be used for a particular analysis with the data remaining converted and since the process is a reversible conversion by which an original map location Z can be restored by using a secret parameter, the user can get a service based on the particular analysis while protecting the privacy and, in addition, can use data stored in the cloud to make the user's own travel history map or the like.

Since the use of access parameters allows the storage provider and the analysis provider to be separated from each other (FIG. 5) and prevents even the travel distance from being calculated from information held by the storage provider, the security can be further improved.

The service provider (insurance company) can obtain more accurate information on safety from actual driving histories and can expect an increase in the number of policyholders by offering a cashback to safe users. On the other hand, the user can also expect a decrease in the number of traffic accidents by driving safely for the cashback. A win-win relationship is built in this way. In addition, since the storage provider does not charge the user for the user storing data in the cloud, but charges when the service provider acquires data from the cloud (via the analysis provider), the user can use the cloud easily, while the storage provider can obtain an assured income. Another win-win relationship is thus built.

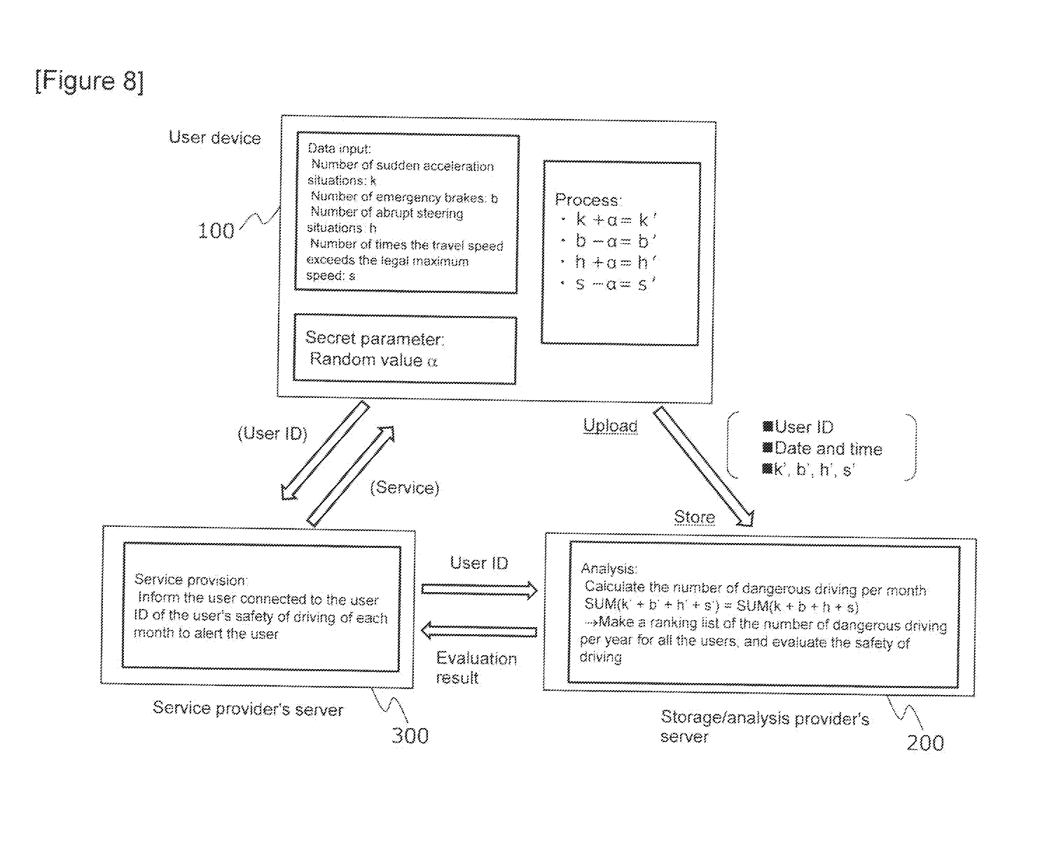

While the description above is of examples in which data collected from each user are separately evaluated and services are provided to each user. FIG. 8 shows an example in which data collected from a plurality of users are generally evaluated and the results (e.g. the level of divergence from the overall average, etc) are used as well to determine details of services to be provided to each user. The following description is made with the configuration in FIG. 2, but the same extension is available in the configuration in FIG. 5.

The user device 100 of the example in FIG. 8 holds a random value α as a secret parameter and inputs, as sensor information, the quantity and speed of accelerator operation, the quantity and speed of brake pedal operation, the rotation speed of the steering wheel, and the traveling speed. The user device 100 determines a situation, where the quantity and speed of accelerator operation meet predetermined conditions, to be sudden acceleration and counts the number of the situations, k; determines a situation, where the quantity and speed of brake pedal operation meet predetermined conditions, to be an emergency brake and counts the number of the situations, b; determines a situation, where the rotation speed of the steering wheel exceeds a predetermined value, to be abrupt steering and counts the number of the situations, h; and counts the number of times the travel speed exceeds the legal maximum speed, s, from the start to the end of travel or during a day, for example.

The user device 100 inputs these numbers k, h, h, and s as data, and uses the secret parameter α to perform a conversion process k+α=k′, b−α=b′, h+α=h′, and s−α=s′. The user device 100 then uploads the user ID, the travel date and time, and the processed data (the number of sudden acceleration situations′, the number of emergency brake situations′, the number of abrupt steering situations′, and the number of times the legal maximum speed is exceeded′) to the storage/analysis provider's server 200, and has it store them.

Adding up the stored data k′, b′, h′, and s′ provides the same value as adding up k, b, h, and s by the addition/subtraction of α, and therefore the storage/analysis provider's server 200 can calculate the number of dangerous driving per month of the user without knowing α. If the number of dangerous driving per month is calculated for all the users from stored data of each user, evaluation can be made on where a certain user ranks in all the users concerning the safety of driving.

The service provider can then provide a service of cashback on the insurance premium depending on the user's rank concerning the safety of driving as with the case of the above-described “pay as you drive” example and, furthermore, can reflect the actual driving level of all the policyholders on that rank. As another example, a service can also be provided at the end of each month that is to inform the user of the user's rank concerning the safety of driving to alert the user.

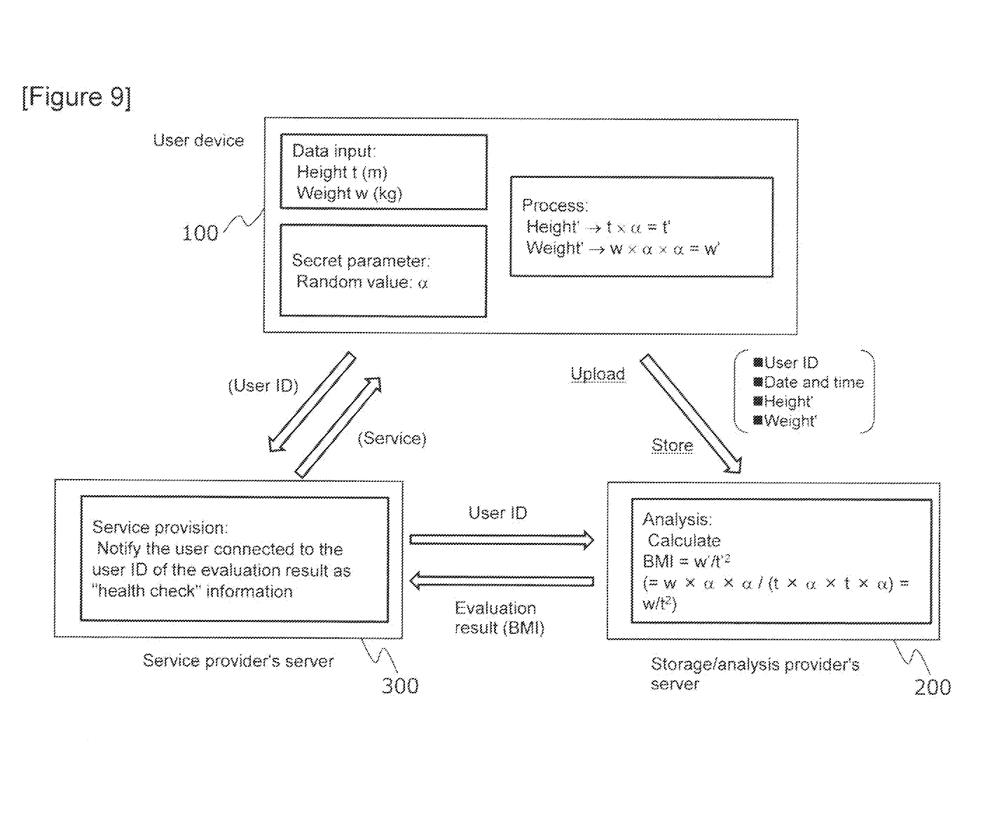

FIG. 9 shows an example of providing a healthcare service as another example that is not automobile-related. This service is to inform a user of a physique index called BMI (Body Mass Index) that is calculated from the relation between weight and height and indicates the degree of obesity.

The user device 100 of the example in FIG. 9 holds a random value α as a secret parameter, and inputs from its sensor the height t (m) and weight w (kg) of a user as data. The user device 100 then uses the secret parameter α to perform a conversion process t×α=t′ and w×α×α=w′, uploads the user ID, the measurement date and time, and processed data (height′ and weight′) to the storage/analysis provider's server 200, and has it store them.

Calculating w′/(t′)² from stored data t′ and w′ according to the equation for BMI provides the same value as calculating w/t² by the multiplication/division of α, and therefore the storage/analysis provider's server 200 can obtain the BMI of the user as an evaluation result without knowing α.

An example of providing a home loan service will be described as another example (not shown). This service is to inform a user of whether the loan repayment ratio falls within the criterion of the ratio or not.

The user device 100 holds a random value α as a secret parameter, and inputs the annual income (before-tax yearly income) y (yen) and planned amount of yearly loan repayment x (yen) of a user as data. The user device 100 then uses the secret parameter α to perform a conversion process y×α=y′ and x×α=x′, uploads the user ID and processed data (yearly income′ and amount of repayment′) to the storage/analysis provider's server 200, and has it store them.

Calculating x′/y′ from stored data y′ and x′ according to the equation for repayment ratio provides the same value as calculating x/y by the multiplication/division of α, and therefore the storage/analysis provider's server 200 can calculate the repayment ratio of the user without knowing α and, by comparing this with a reference ratio, obtain an evaluation result, i.e. whether the loan repayment is adequate or not.

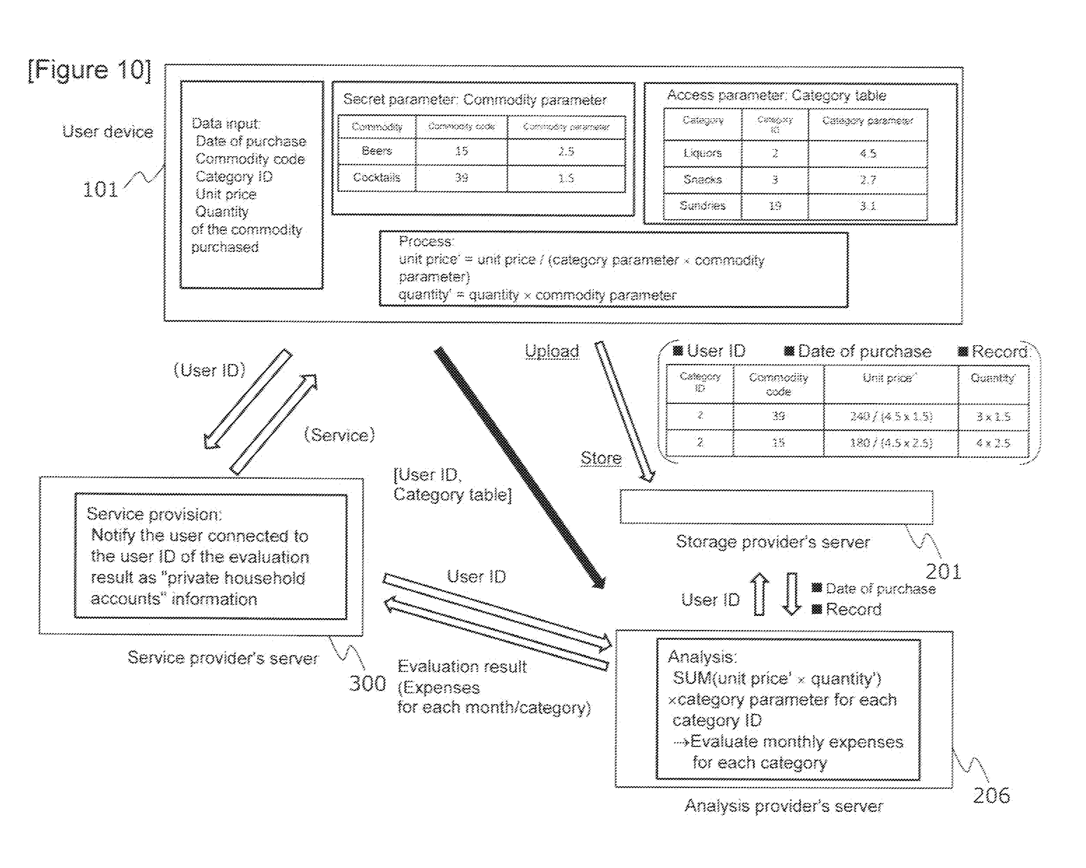

FIG. 10 shows an example of providing a private household accounts service as a service provided with the configuration in FIG. 5, which is also different from the example described above.

The user device 101 holds commodity parameters defined for each commodity (2.5 for beers (commodity code=15), 1.5 for cocktails (commodity code=39), etc.) as secret parameters, and holds a category table including category parameters defined for each category (4.5 for liquors (category ID=2), 2.7 for snacks (category ID=3), 3.1 for sundries (category ID=19), etc.) and category information meant by each category ID as access parameters. In the example in FIG. 10, which commodity each commodity code means is also treated as a secret parameter.

A commodity code and commodity parameter for a certain commodity and a category ID and category parameter for a certain category are defined in a random manner for each user, and are values that are kept secret from a third party unless notice is given from the relevant user. Those other than the user are not informed of pieces of information on commodities (detailed information) which are the secret parameters, but only the analysis provider is informed of pieces of information on the category table (general information) which are the access parameters.

When a user purchases a commodity, the date of purchase, commodity code, category ID, unit purchase price, and quantity of purchase of the commodity are input as data to the user device 101. For example, if a user, Mr. A, has purchased three beers at 240 yen a piece and four cocktails at 180 yen a piece, data “commodity code=15, category ID=2, unit price=240 yen, quantity=3” and “commodity code=39, category ID=2, unit price=180 yen, quantity=4” are input.

The user device 101 performs a conversion process in which the unit price is divided by (category parameter×commodity parameter) to determine the unit price′ and the quantity is multiplied by the commodity parameter to determine the quantity′, uploads the user ID, the date of purchase, and a record consisting of “commodity code, category ID, processed data (unit price′, quantity′)” to the storage provider's server 201, and has it store them. These stored data indicate that some commodity in some category has been purchased. However, they do not show any of what the category is, what the commodity is, how much the unit price of the commodity is, and how much quantity is purchased. Even if a calculation, unit price′×quantity′, is made to cancel the commodity parameter by multiplication/division, no analysis can provide information on how much the purchase amount of the commodity is, since the data has been further divided by the category parameter.

The above-described values of category parameters and information on which categories category IDs mean are information included in the category table held by the user, and this category table is passed to the analysis provider's server 206 as access parameters along with the user ID. The analysis provider's server 206 can then acquire from the storage provider's server 201 records belonging to a month that includes the date of purchase with the specified user ID, sum up unit price′×quantity′ over records with a particular category ID (e.g. 2), and multiply the sum total by the category parameter (e.g. 4.5) for the relevant category ID, thereby calculating how much in total the commodities belonging to the relevant category ID were purchased in that month, and finding which category the relevant category ID means as well.

The analysis provider's server 206 can therefore obtain the user's monthly expenses for each category as an evaluation result (e.g. how much is spent on liquor, how much is spent on sundries, etc.) by acquiring the category table as access parameters. The service provider's server 300 can then acquire this evaluation result from the analysis provider's server 206 and provide the user with it as private household accounts information.

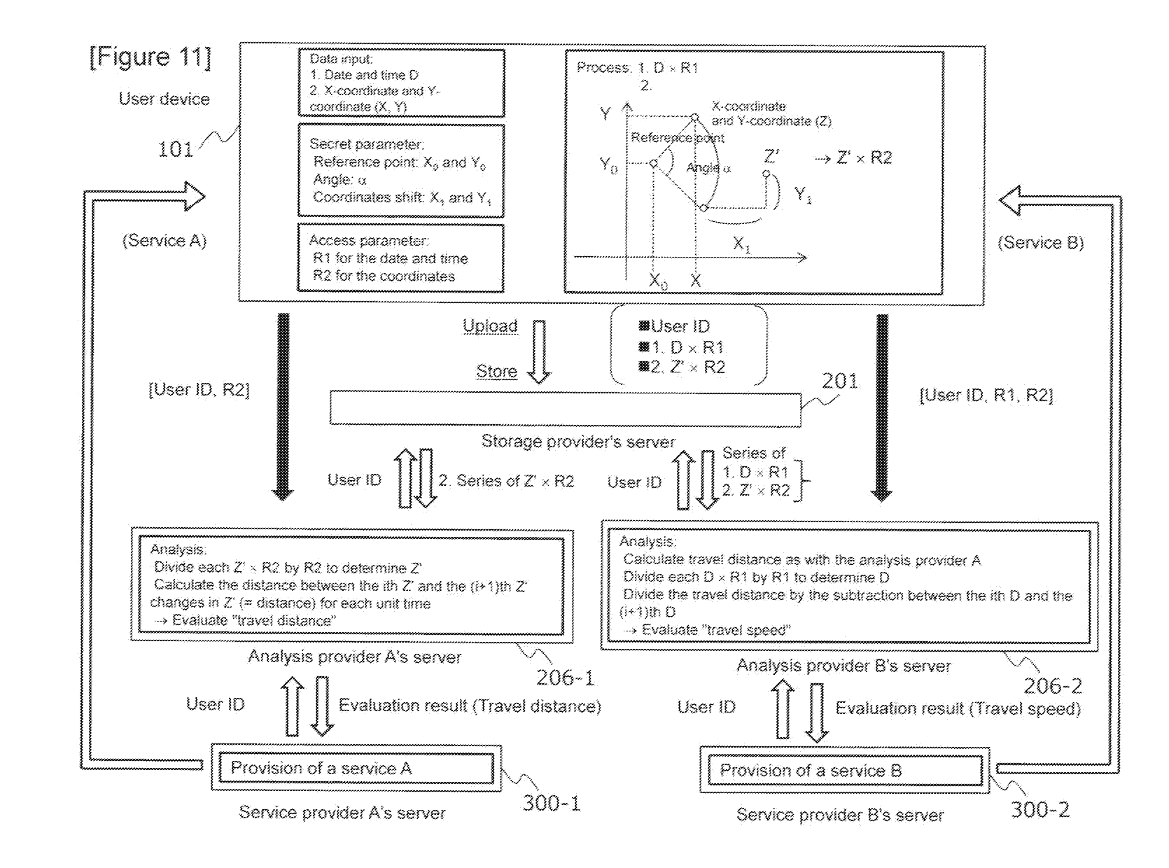

In an example in FIG. 11, neither of the analysis providers use information on commodity codes for analysis, and therefore a record may be passed from the storage providers server to each analysis provider's server without the item for commodity codes. The reason information not used for analysis is also stored on the storage provider's server (in the cloud) is to allow the user, when the user downloads the user's own data stored in the cloud and runs a more detailed household accounts application, to perform analysis for each commodity in greater detail than for each category or to perform analysis using information on the unit price and quantity which is more detailed than that on the purchase amount by reading a secret commodity parameter with a commodity code being the key.

The introduction of access parameters provides an advantage that analysis can be performed while the risk of information leakage is dispersed, as described above, and can also provide an advantage of diversification of analysis. That is, since the use of access parameters allows only a minimum of information to be retrieved as appropriate from among hidden data and be used for calculation, only information among hidden data that is required for each of a plurality of analysis providers can be used for their calculation to perform diversified analyses and provide diversified services while keeping a lid on the risk of information leakage.

FIG. 11 shows an example in which an analysis provider A's server 206-1 and an analysis provider B's server 206-2 analyze independently of each other. In the example in FIG. 11, the analysis provider B can perform the same analysis as the analysis provider A and another detailed analysis.

In the configuration in FIG. 11, a service provider A's server 300-1 provides a user with a service A based on an analysis performed by the analysis provider A, and a service provider B's server 300-2 provides the user with a service B based on an analysis performed by the analysis provider B. However, there may be a configuration in which the services A and B are provided by one service provider's server.

The user device 101 in the example in FIG. 11 inputs the date and time D and a map location (X-coordinate and Y-coordinate) as sensor information. The same parameters as in the example in FIG. 5 are stored as secret parameters, and R1 for the date and time and R2 for the coordinates are stored as access parameters.

The user device 101 then performs the process f on the input map location Z (X-coordinate and Y-coordinate), in which it uses the secret parameters to rotate the location clockwise around the reference point through the angle and moves it by the travel distance, to obtain Z′, which is then multiplied by the access parameter R2. The user device 101 further performs a process in which the input date and time D is multiplied by the access parameter R1, uploads D×R1 and Z′×R2 as well as the user ID, and has the storage provider's server 205 store them.

The analysis provider A's server 206-1 acquires a series of Z′×R2 for a certain user ID from the storage provider's server 201, reads the value of the access parameter R2 that it received and holds for the user ID, and divides each Z′×R2 by R2 to determine each Z′. The analysis provider A can then calculate the distance between neighboring Z's (the i-th Z′ and the (i+1)-th Z′) to determine each travel distance as an evaluation result.

The analysis provider B's server 206-2 acquires series of D×R1 and Z′×R2 for a certain user ID from the storage provider's server 201, reads the values of the access parameters R1 and R2 that it received and holds for the user ID, and divides each D×R1 by R1 and each Z′×R2 by R2. The analysis provider B can then determine not just the distance between the i-th Z′ and the (i+1)-th Z′, i.e. the travel distance, but also each travel speed as evaluation results by determining the temporal subtraction between the i-th D and the (i+1)-th D and dividing corresponding travel distance by the temporal subtraction.

In the example in FIG. 11, two access parameters are established to store time information and distance information multiplied by each parameter as data; the access parameter by which the distance information can be divided is passed to one analysis provider in order to allow it to calculate only distance; and the access parameter by which the time information can be divided and the access parameter by which the distance information can be divided are passed to the other analysis provider in order to allow it to calculate speed. This can limit information that is allowed to be calculated by each analysis provider.

The date and time would be uploaded as it is in the examples in FIGS. 8 and 9. These examples, however, may also be configured in such a way that the date and time D is uploaded after it is multiplied by the access parameter R and the access parameter R is passed only to an analysis provider that requires information on date and time for analysis.

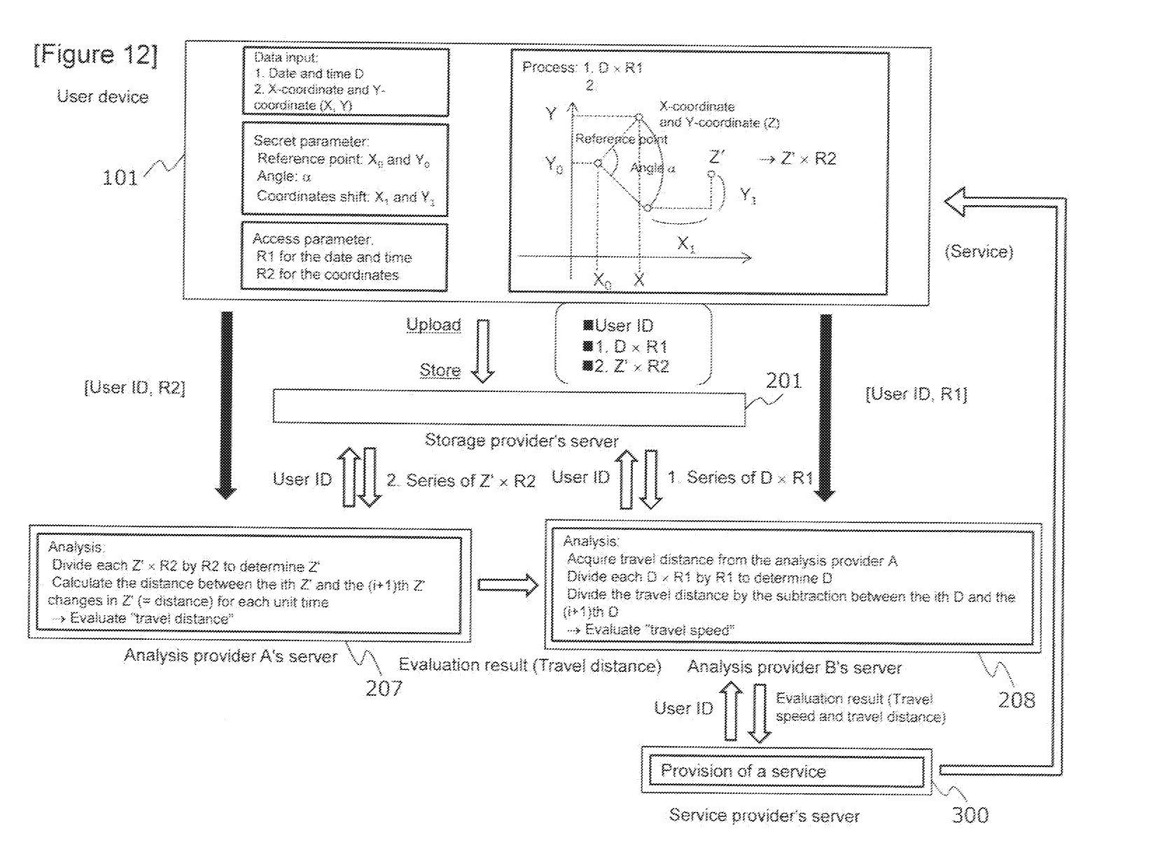

If as in the example in FIG. 11 the analysis performed by the analysis provider B comprises the analysis performed by the analysis provider A and a further detailed analysis, the configuration may be like that shown in FIG. 12. Specifically, the analysis provider B may receive an analysis result from the analysis provider A instead of performing for itself the same analysis as the analysis provider A (calculation of the distance in the example above), and perform an additional analysis (calculation of the time and speed in the example above).

In this case, as shown in FIG. 12, an analysis provider A's server 207 calculates the distance between the i-th Z′ and the (i+1)-th Z′ as is the case with the analysis provider A's server 206-1 in FIG. 11, and passes the calculation result (a combination of i and the travel distance) to an analysis provider B's server 208 along with the user ID.

Upon receiving the above-described calculation result from the analysis provider A, the analysis provider B's server 208 acquires a series of D×R1 for the relevant user ID from the storage provider's server 201, reads the value of the access parameter R1 that it received and holds for the user ID, and divides each D×R1 by R1 to determine the temporal subtraction between the i-th D and the (i+1)-th D (a combination of i and the temporal subtraction). The analysis provider B can then determine the travel speed as an evaluation result by dividing the travel distance combined with i by the temporal subtraction.

In the example in FIG. 12, the analysis provider B provides two evaluation results, namely the travel distance and the travel speed, to one service provider. However, the analysis provider A may provide the evaluation result of the travel distance and the analysis provider B may provide the evaluation result of the travel speed, both to one service provider. Alternatively, in the example in FIG. 12 and as in FIG. 11, there may be the service provider A that receives the evaluation result of the travel distance from the analysis provider A and provides the service A and the service provider B that receives the evaluation result of the travel speed from the analysis provider B and provides the service B.

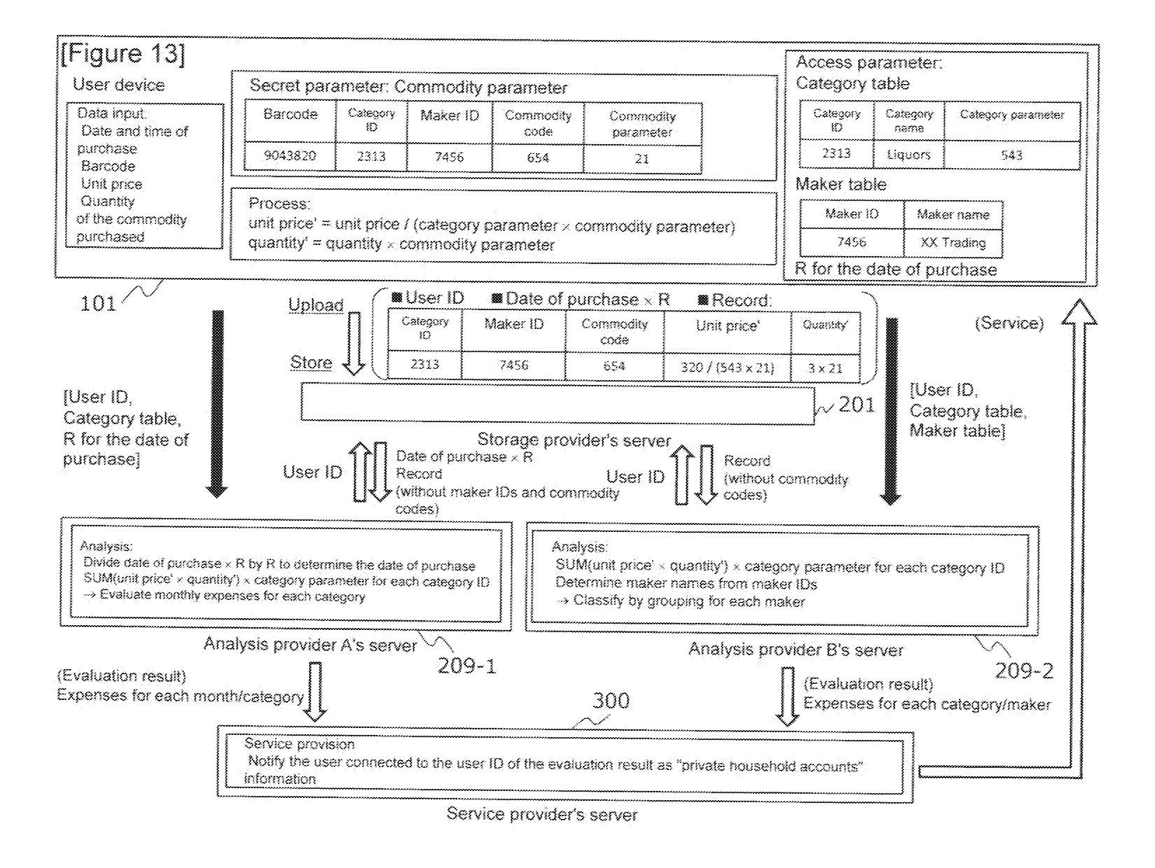

FIG. 13 shows an example in which an analysis provider A's server 209-1 and an analysis provider B's server 209-2 analyze independently of each other. In the example in FIG. 13, the analysis performed by the analysis provider A and the analysis performed by the analysis provider B are not in an inclusive relation and have details different from each other.

The user device 101 in the example in FIG. 13 holds commodity parameters defined for each commodity as secret parameters. Commodities are to be identified by barcodes attached thereto in this example. While category IDs, maker IDs, and commodity codes are pieces of information that can be determined from the barcodes, a configuration in which an identical barcode determines values different for different users would be able to prevent commodities from being identified even if the category IDs, maker IDs, and commodity codes are publicly released (would allow correspondences between these pieces of information and the barcodes to be the secret parameters).

The user device 101 in FIG. 13 also holds, as access parameters, a category table including category parameters defined for each category and category names meant by each category ID, a maker table including maker names meant by each maker ID, and R for the date of purchase.

When a user purchases a commodity, the date and time of purchase, barcode, unit purchase price, and quantity of purchase of the commodity are input as data to the user device 101. For example, where an IC card such as a loyalty card is the user device 101, a cash register in the store inputs to the user's loyalty card the barcode, unit price, and quantity of the commodity read with its reader, and the secret parameters and access parameters stored in the loyalty card are used to perform calculations of the unit price′ and quantity′ or the like in the loyalty card.

Specifically, the user device 101 (the loyalty card in the example above) performs: a conversion process in which the unit price is divided by (category parameter×commodity parameter) to determine the unit price′ and the quantify is multiplied by the commodity parameter to determine the quantity′; a conversion process for determining the category ID, maker ID, and commodity code from the barcode; and a conversion process of multiplying the date and time of purchase by R. The user device 101 then uploads the user ID, the date of purchase×R, and a record consisting of “category ID, maker ID, commodity code, unit price′, quantity′” to the storage provider's server 201, and has it store them.

These stored data indicate that some commodity in some category made by some maker has been purchased. However, they do not show any of what the category is, what the commodity is, what the maker is, how much the unit price of the commodity is, and how much quantity is purchased. Even if a calculation, unit price′×quantity′, is made to cancel the commodity parameter by multiplication/division, no analysis can provide information on how much the purchase amount of the commodity is, since the data has been further divided by the category parameter.

The above-described values of category parameters and information on which categories category IDs mean are information included in the category table held by the user, and this category table information is passed to the analysis provider A's and B's servers 209-1 and 209-2 as access parameters along with the user ID.

In addition to the category table described above, the analysis provider A's server 209-1 receives and stores the value of R for the date and time of purchase held by the user, too, as an access parameter. The analysis provider A's server 209-1 can then acquire the date and time of purchase×R from the storage provider's server 201 and divide it by the access parameter R to find the date and time of purchase for each record. The analysis provider A's server 209-1 can therefore sum up unit price′×quantity′ for each category ID over records, among those acquired from the storage provider's server 201, whose date and time of purchase satisfies certain conditions (e.g. is in the specified month, is in a specified time period, etc.), and multiply the sum total by the category parameter for the relevant category ID, thereby calculating how much in total the commodities belonging to the relevant category ID were purchased, and finding which category the relevant category ID means as well. The analysis provider A can thus inform the service provider of the expenses for each category within specified date and time conditions as an evaluation result, and the user can be provided with a private household accounts service.

In addition to the category fable described above, the analysis provider B's server 209-2 receives and stores information on the maker table held by the user, too, as access parameters. The analysis provider B's server 209-2 can then, over a group of records acquired from the storage provider's server 201 (e.g. for a month) and with the knowledge of category names meant by each category ID and maker names meant by each maker ID, sum up unit price′×quantity′ for each combination of the category ID and the maker ID, and multiply the sum total by the category parameter for each category ID, thereby calculating for each maker how much in total the commodities belonging to the category were purchased. The analysis provider B can thus inform the service provider of an evaluation result of the expenses for each category during a certain time period and further divided for each maker, and the user can be provided with a private household accounts service.

The analysis provider B's server 209-2 also can do something like determining an evaluation result of the expenses for each category and each user ID during a certain time period and further divided for each maker, and then summing up the expenses for each category and each maker over all the users, thereby making a maker ranking list for popularity (the amount of sale proceeds) in each category. The service provider may provide such a ranking list made by the analysis provider B to the user as recommendation information, or to a maker as research information. In the latter case, the maker rather than the user may pay a charge for the service provision to the service provider (part of which is distributed to the analysis provider and storage provider).

In the configuration in FIG. 13, a service A based on an analysis performed by the analysis provider A and a service B based on an analysis performed by the analysis provider B are provided by one service provider's server 300. However, there may be a configuration in which a service provider A's server 300-1 provides the user with the service A and a service provider B's server 300-2 provides the user with the service B. Particularly, as described above, the service providers A and B may exist separately from each other in such a case where the service A (the provision of information on monthly expenses for each category) is a service for users and the service B (the provision of information on sale proceeds for each category and each maker) is a service for makers.

In the example in FIG. 13, neither of the analysis providers use information on commodity codes for analysis, and the analysis provider A does not use information on maker IDs for analysis, either. Therefore, a record may be passed from the storage provider's server to the analysis provider A's server without the items for maker IDs and commodity codes, and a record may be passed from the storage provider's server to the analysis provider B's server without the item for commodity codes. When the user downloads the user's own data stored in the cloud and runs a more detailed household accounts application, the user can perform analysis for a specified commodity in greater detail than for each category or restore information on the unit price and quantity to perform analysis, by reading a secret commodity parameter and a barcode with a category ID, maker ID, and commodity code being the key.

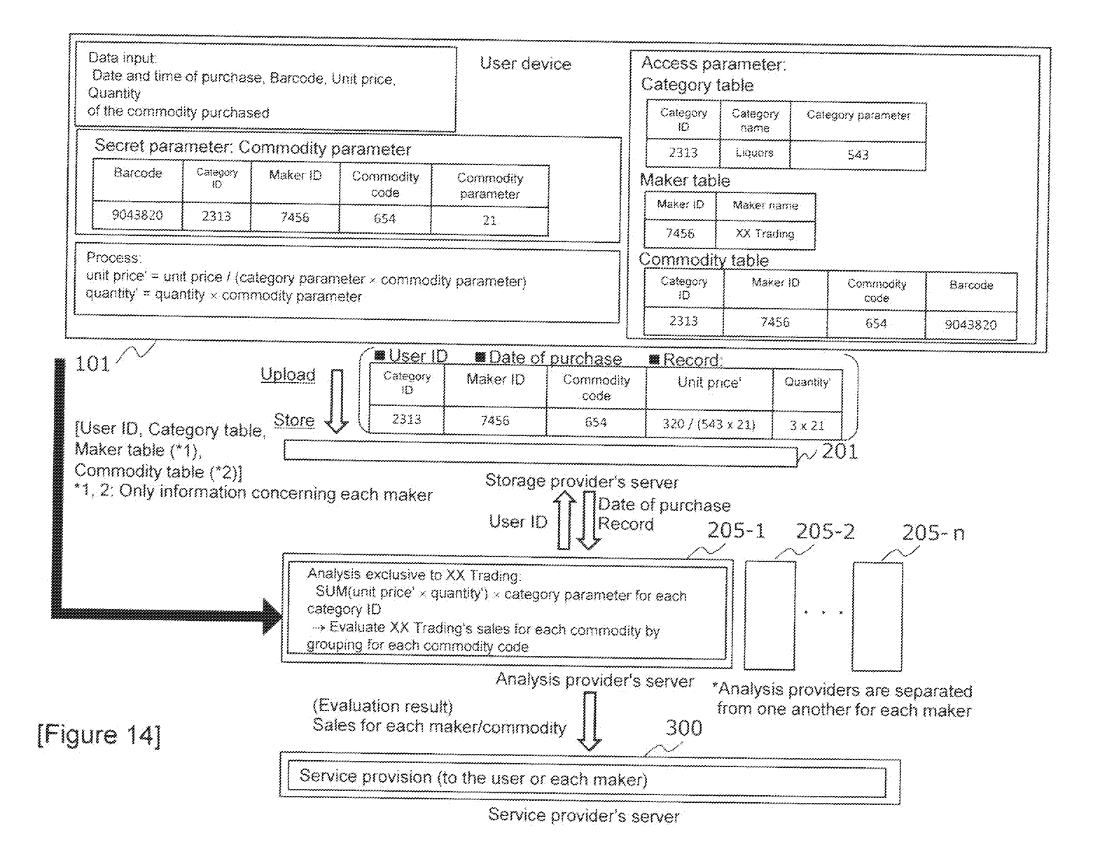

FIG. 14 shows an example in which a plurality of analysis providers' servers 205-1, 205-2, . . . , 205-n analyze independently of one another. In the example in FIG. 13, in order to prevent barcodes from being determined (to prevent commodities from being identified) from category IDs, maker IDs, and commodity codes, correspondences between these pieces of information and the barcodes are kept secret to everyone except the user. In the example in FIG. 14, however, they are arranged in a commodity table to be access parameters that are disclosed only to limited analysis providers.

In the example in FIG. 13, information that can be calculated is limited for each analysis provider in such a way that the analysis provider A does not use an item, maker ID, from among data stored on the storage provider's server nor the maker table from among the access parameters, and the analysis provider B does not use an item, date and time of purchase, from among data stored on the storage provider's server nor R for the date and time of purchase from among the access parameters.

In the example in FIG. 14, on the other hand, information that can be calculated is limited for each analysis provider in such a way that the analysis provider A uses only data whose maker ID indicates a maker A from among data stored on the storage provider's server and uses only an entry whose maker ID is the maker A from among the commodity table being access parameters, and the analysis provider B uses only data whose maker ID indicates a maker B from among data stored on the storage provider's server and uses only an entry whose maker ID is the maker B from among the commodity table being access parameters.

In other words, in the example in FIG. 14, access parameters passed to the analysis provider include the commodity table being parameters by which the commodity can be identified (commodity code; commodity name), and therefore the analysis provider can add up how much of which commodities were sold. As shown in FIG. 14, however, the plurality of analysis providers' servers 205-1 205-2, . . . , 205-n are arranged in such a way that different providers analyze for different makers and, when the commodity table is passed as access parameters, only parameters for the maker to be handled by the relevant analysis provider are passed.

Accordingly, each analysis provider in FIG. 14 can obtain detailed information, i.e. the amount of sale proceeds for each commodity, as to a maker it handles, but only general information, i.e. just for each category, as to the other makers. In addition, since an analysis provider cannot identify a user from a user ID and therefore cannot figure out a holder of a purchase history, and since analysis providers are separated from one another for each maker, detailed analysis can be performed with the security of data being maintained.

The service provision based on analyses in FIG. 14 may be done in such a way that each analysis provider performs the analysis for each commodity described above for each user ID, and the user with the user ID is provided with the analysis results for all the makers, or that each analysis provider sums up the analysis results for each commodity described above over all the users, and provides the result to a maker if handles. While FIG. 14 shows the configuration in which one service provider's server 300 provides services, a plurality of service providers' servers 300-1, 300-2, . . . , 300-n may be arranged in such a way that different providers provide services for different makers (different analysis providers).

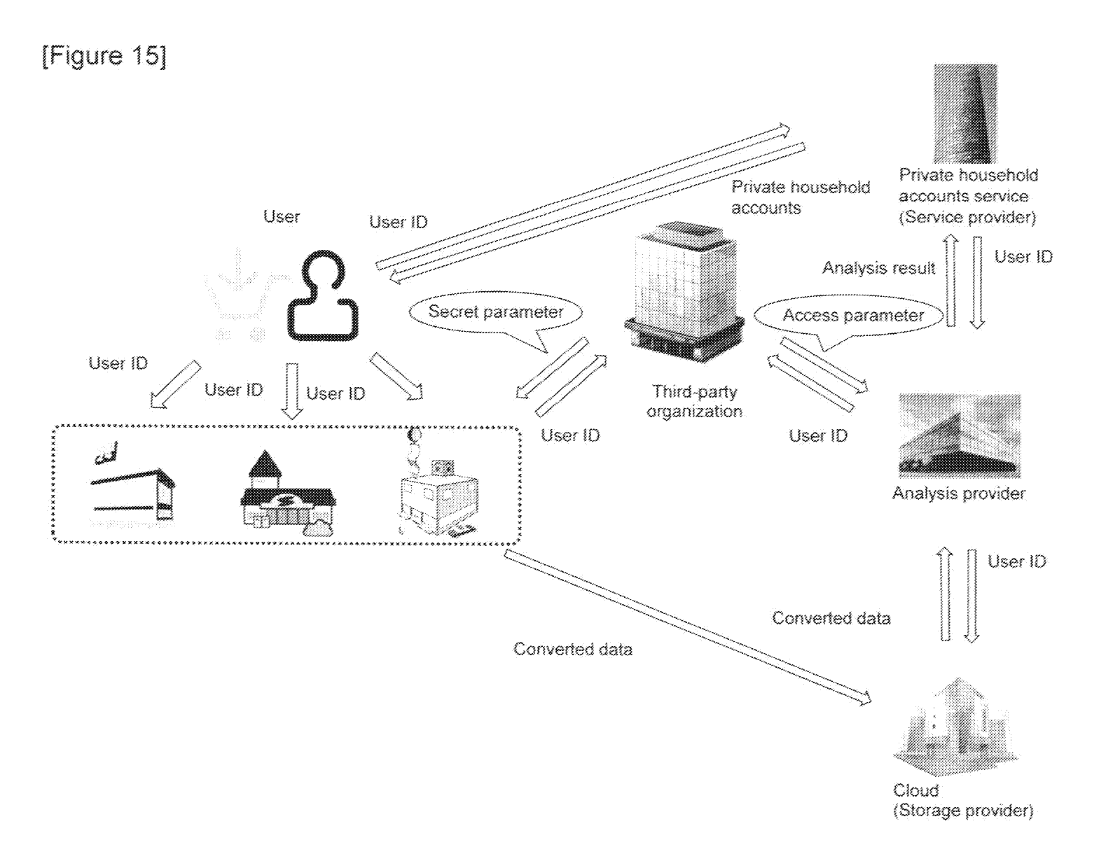

FIG. 15 shows an example of a configuration for allowing a reliable third-party organization to manage secret and access parameters instead of storing them on a user device. This is particularly useful when mapping tables may expand too much to be stored on a loyalty card, or in a case where an individual managing mapping tables may encounter difficulty in updating them when a new type of commodity is added, as in the example in FIG. 14.

All the secret and access parameters described in FIGS. 1 to 14 as being held by a user device can be held by the third-party organization's server in FIG. 15. In such case, a user device acquires secret and access parameters from the third-party organization's server when performing a process using them, and an analysis provider's server acquires necessary access parameters when performing an analysis using them. The consolidated management by the third-party organization can fix the problems described above, and can reduce the risk of information leakage if it is separated from storage providers even though it holds secret parameters.

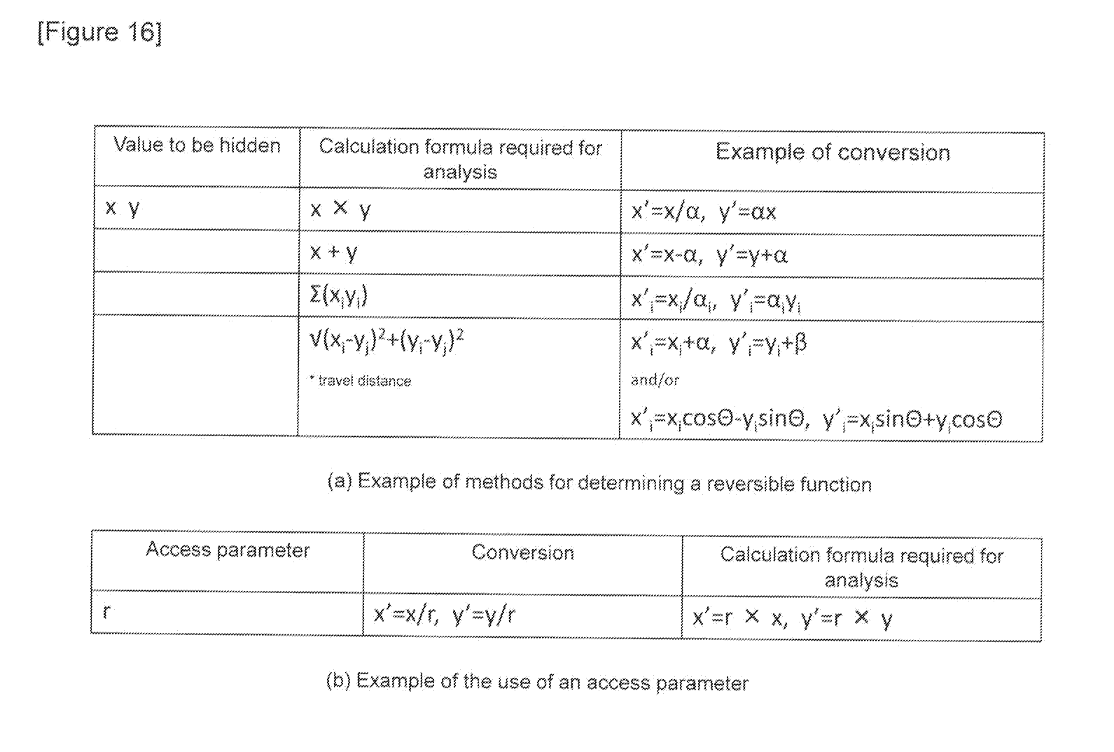

Shown below with reference to FIG. 16 is an example of methods for defining a conversion process (reversible function) to be performed in the user device.

First, information including privacy to be managed in the cloud and an object to be analyzed by using the information are determined. As for the example of “pay as you drive,” the private information is X-coordinate and Y-coordinate, and the object to be analyzed is calculation of travel distance for each unit time. As for the example of healthcare, the private information is height and weight, and the object to be analyzed is calculation of BMI. As for the example of private household accounts, the private information is the purchase history of commodities, and the object to be analyzed is a breakdown of monthly purchases (for each category).

Reversible functions for concealing private information are then derived from the calculation method required for analysis. As for the example of “pay as you drive,” since it is enough if the relative distance can be calculated and if the reference point is identical even if X-coordinate and Y-coordinate do not indicate the actual location, the absolute position of X-coordinate and Y-coordinate is shifted in accordance with a certain rule (a secret parameter known only to the relevant user). As for the example of healthcare, since it is enough if BMI can be calculated and if BMI can be derived by calculation even if height and weight are not known, height and weight are separately processed with a random value (a secret parameter known only to the relevant user) in such a way that the random value is canceled in the calculation of BMI. As for the example of private household accounts, since it is enough if the sum total can be calculated for each category from a monthly purchase history and if the total value can be derived for each category of commodities from the calculation of the total amount, which is unit price×quantity, even if the unit price and quantity are not known, the unit price and quantity are converted to unit price/random number and quantity×random number by using an identical random number (a secret parameter known only to the relevant user).

In short, a conversion process is defined in accordance with a specific analysis method and private information to be handled so that the functional conversion performed for concealing private information is canceled in calculation for analysis.

Access parameters may be considered as a step of the process of the reversible function calculation method. Specifically, multiplication/division or addition/subtraction may be performed with an access parameter on the result acquired by using a reversible function. As for the example of private household accounts, either unit price or quantity is divided in advance by a random number (access parameter) other than a secret parameter so as to prevent an adversary from obtaining an accurate analysis result (the total amount) even if the adversary gets data of unit price/random number and quantity×random number and calculates unit price×quantity. When divided, the calculation result just has to be multiplied by the access parameter in the analysis, and when multiplied, the calculation result just has to be divided by the access parameter in the analysis. The same also applies to the case of addition/subtraction.

As described above, if data to be hidden and a calculation method required for analysis are fixed, the reversible function can be defined by combining the conversion methods shown in FIG. 16. The secret parameter is α in FIG. 16, and the access parameter is γ in FIG. 16.

In addition, if conversions and the digit number of α in FIG. 16 are combined and as the digit number for conversion and the number of conversions increases, more time will be required for decryption using an exhaustive search (a brute-force method) by which the secret α is analyzed in a round-robin manner, and therefore the security of the reversible function can be strengthened.

Advantages of the access parameter include the dispersion of the risk of information leakage and the diversification of analysis as described above and, if the access parameter is considered to be part of variables of the reversible function, also include an improvement in security due to just an increase in the number of conversions. For example, provided the value of an original data item is 10 and if it is multiplied by a secret parameter α=40231327 as well as by an access parameter γ=349832 and is stored, then those other than the user do not know α and those other than the user and analysis provider do not know γ, and therefore the data item is considered to be converted twice with α and γ, with the security being increased as much.

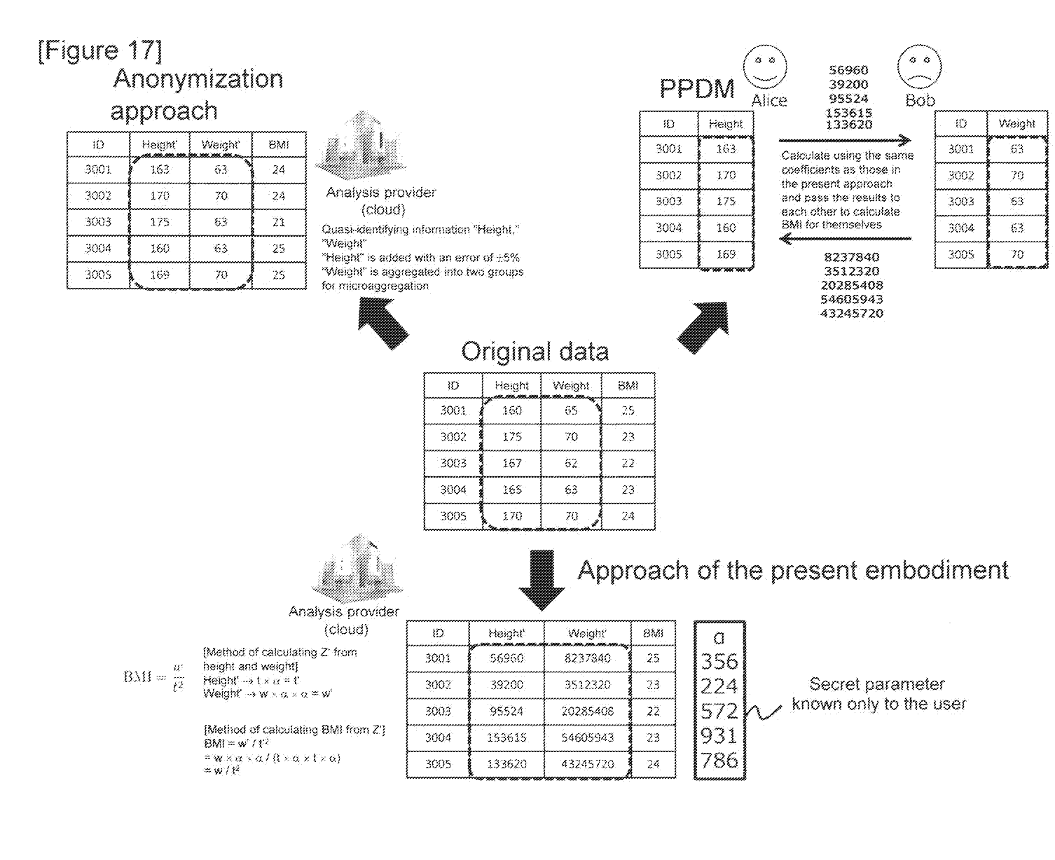

FIG. 17 shows difference between the anonymization approach and PPDM of the prior art and the method of the present embodiment, taking BMI as an example. For example, even if the anonymization approach is used to delete a name or other information identifying an individual, the presence of information on changes in height and weight (e.g. lost 20 kg recently, etc.) might allow the individual to be identified by checking the information against a measurement result at a fitness club or the like, and grouping the values of height and weight by range would prevent accurate derivation of the value of BMI. As for PPDM, a company A (Alice) and a company B (Bob) hold original data D_{A} and D_{B}, respectively, and therefore a data leakage from either D_{A} or D_{B} would lead to private information leakage, which is a risk.

In contrast, the method of the present embodiment allows data to be converted and thus stored with private information not included, prevents the original data from being restored even if one of a plurality of players is cracked, and therefore can reduce the risk of leakage. Furthermore, since it's not that part of data are deleted, the user can restore the original data, and can obtain an accurate calculation result (the value of BMI) from analysis. The use of the reversible function in accordance with details of analysis allows a calculation result to be obtained without a huge calculation cost unlike the encryption approach.

As stated above, since the present method allows data to be regularly uploaded to and stored on a network, thereby saving the necessity of storing them on the user's local device and allowing the data on the network to be stored with private information being concealed, privacy is protected even if the information leaks from the network. Though data are converted so as to hide privacy as above, a third party can use the converted data for specific processes and analyses, and the user can always access the original data to produce highly value-added information. The adoption of access parameters allows only a specified third party to obtain results with specific meanings from the hidden data.

While embodiments of the invention have been illustratively described, the invention is not limited by the description herein and it is a matter of course that various changes and applications may be made thereto within the scope of the invention by those skilled in the art.

1. A service provision system comprising:
a first server tor being connected to a user device via a network and continuously receiving from the device and storing personal data of a user; and
a second server for providing the user with a service based on data stored on the first server,
wherein the service is provided by using a result of an analysis based on two or more personal information items of the user,
wherein data received from the device and stored by the first server are data after a process has been performed in the device by using a secret parameter of the user on at least respective parts of data input for the two or more information items, and
wherein the process is defined such that performing the analysis based on the two or more information items on data stored on the first server produces a same result as performing the analysis based on the two or more information items on data input in the device, whereby the analysis is performed in the service provision system without the secret parameter being used.

2. The service provision system according to claim 1,
wherein the first server comprises a unit that, in response to a request from a user, sends stored personal data of the user, and
wherein the user can restore the data input in the device by using the secret parameter to perform a process reverse to the process on data sent from the first server.

3. The service provision system according to claim 1,
wherein the first and second servers are operated by providers different from each other,
wherein the analysis is performed by a computer of the provider operating the first server, and
wherein the second server receives a result of the analysis to provide a service using the result.

4. The service provision system according to claim 3,
wherein information identifying a user to be provided with the service is managed by a computer of the provider operating the second server, the computer comprising a unit that issues an ID to the user whose information is managed,
wherein the first server receives the ID as well as personal data of the user, and
wherein data to be stored and analyzed and a result of the analysis are managed according to the ID.

5. The service provision system according to claim 1,
wherein data received from the device and stored by the first server are data after an additional process has been performed in the device by using an additional parameter of the user on data tor at least part of the information items processed by rising the secret parameter,
wherein the service provision system comprises a unit that receives the additional parameter used in the device for the purpose of the analysis, and
wherein the process and the additional process are defined such that performing the analysis based on the two or more information items, including an additional analysis using the additional parameter, on data stored on the first server produces a same result as performing the analysis based on the two or snore information items on data input in the device, whereby the analysis is performed in the service provision system without the secret parameter being used.

6. The service provision system according to claim 1,
wherein data received from the device and stored by the first server are data after an additional process has been performed in the device by using an additional parameter of the user on data for information items not processed by using the secret parameter,
wherein the service provision system comprises a unit that receives the additional parameter used in the device tor the purpose of the analysis, and
wherein the process and the additional process are defined such that performing the analysis based on the two or more information items, including an additional analysis using the additional parameter, on data stored on the first server produces a same result as performing the analysis based on the two or more information items on data input in the device, whereby the analysis is performed in the service provision system without the secret parameter being used.

7. The service provision system according to claim 5,
wherein the first and second servers are operated by providers different from each other,
wherein the analysis is performed by a computer of the provider operating the second server, and
wherein the second server receives data stored on the first server and the additional parameter used in the device to perform the analysis and provide a service using a result of the analysis.

8. The service provision system according to claim 5, further comprising a third server for performing the analysis,
wherein the first, second, and third servers are operated by providers different from one another,
wherein the third server receives data stored on the first server and the additional parameter used in the device to perform the analysis, and
wherein the second server receives a result of the analysis to provide a service using the result.

9. The service provision system according to claim 6,
wherein the service comprises a first service that uses a result of an analysis based on the information items processed by using the secret parameter; and a second service that uses the result of the analysis and a result of an additional analysis based on the information items additionally processed by using the additional parameter,
wherein the service provision system further comprises: a third server for performing an analysis for the first service; and a fourth server for performing an analysis for the second service,
wherein the third and fourth servers are operated by providers different from each other, and
wherein the fourth server comprises a unit that receives the additional parameter used in the device.

10. The service provision system according to claim 6,
wherein the service comprises: a service that uses a result of a first analysis based on at least part of the two or more information items; and a service that uses a result of a second analysis based on another part of the two or more information items, and
wherein data for information items cm which the first analysis is based have been additionally processed by using a first additional parameter of the user, and data tor information items on which the second analysis is based have been additionally processed by using a second additional parameter of the user.

11. The service provision system according to claim 6,
wherein the service comprises: a service that uses a result of a first analysis performed on data, one of the two or more information items of which belongs to a first group; and a service that uses a result of a second analysis performed on data, one of the two or more information items of which belongs to a second group, and
wherein data on which the first analysis is to be performed have been additionally processed by using a first additional parameter of the user, and data on which the second analysis is to be performed have been additionally processed by using a second additional parameter of the user.

12. The service provision system according to claim 6, further comprising: a third server for performing the first analysis; and a fourth server for performing the second analysis,
wherein the third and fourth servers are operated by providers different from each other,
wherein the third server receives data stored on the first server and a first additional parameter used in the device to perform a first analysis, and
wherein the fourth server receives data stored on the first server and the second additional parameter used in the device to perform a second analysis.

13. The service provision system according to claim 1,
wherein the service is provided to each of a plurality of users by using results of the analysis based on the two or more personal information items of each user and performed on the plurality of users.

14. The service provision system according to claim 1, comprising a unit that assigns a secret unique value to the user,
wherein the secret and additional parameters are random numbers generated from the unique value in accordance with predetermined rules.

15. The service provision system according to claim 1,
wherein the device acquires the secret and additional parameters, from a server outside the system that holds the secret and additional parameters for the user, to perform the process, and
wherein the service provision system receives the additional parameter from the server outside the system.

16. The service provision system according to claim 1,
wherein if the analysis includes any of the multiplication of x by y, the addition of x to y, the summation of the product of xᵢ and yᵢ over i (i represents natural numbers), and the distance between two points in an x-y coordinate system, where x and y are the two or more information items, then the process includes dividing x by α and multiplying y by α (α is the secret parameter), subtracting α from x and adding α to y (α is the secret parameter), dividing xᵢ by αᵢ and multiplying yᵢ by αᵢ (each αᵢ is the secret parameter), and shifting the x coordinate of each point by α and the y coordinate of each point by β (α and β are the secret parameters) and/or rotating the x and y coordinates of each point around a reference point through θ (θ is the secret parameter), respectively.

17. The service provision system according to claim 5,
wherein if the analysis includes any of the multiplication of x by y, the addition of x to y, the summation of the product of xᵢ and yᵢ over i (i represents natural numbers), and the distance between two points in an x-y coordinate system, where x and y are the two or more information items, then the additional process includes multiplying or dividing either one of x and y by γ (γ is the additional parameter), adding or subtracting γ to or from either one of x and y (γ is the additional parameter), multiplying or dividing either one of xᵢ and yᵢ by γᵢ (each γᵢ is the additional parameter), and multiplying the x and y coordinates of each point by γ (γ is the additional parameter), respectively.

18. The service provision system according to claim 6,
wherein if the analysis includes the summation of the product of xᵢ and yᵢ over i (i represents natural numbers), or the distance between two points in an x-y coordinate system, where x and y are the two or more information items, then the additional process includes representing i or what each point means with an ID (information that allows details to be identified from the ID is the additional parameter).

19. A service provision method comprising:
continuously sending personal data of a user from a user device to a server connected thereto via a network and allowing the data to be stored;
performing, based on data stored on the server, an analysis based on two or more personal information items of the user; and
using a result of the analysts to provide the user with a service,
wherein the device sends to the server data after a process has been performed by using a secret parameter of the user on at least respective parts of data input for the two or more information items, and
wherein the process is defined such that performing the analysis based on the two or more information items on data stored on the server produces a same result as performing the analysis based on the two or more information items on data input in the device, whereby the analysts is performed without the secret parameter being output from the device.

20. A program for causing a computer, capable of communicating with a storage server that stores personal data of a user continuously received form a user device via a network, to perform an analysis of the data for providing the user with a service based on the data,
wherein the analysis is based on two or more personal information items of the user, the program causing the computer to comprise:
a unit that acquires from the storage server data after a process has been performed by using a secret parameter of the user on at least respective parts of data input in the device for the two or more information items, as data received from the device and stored on the storage server; and
a unit that performs without using the secret parameter the analysis on data acquired from the storage server,
wherein the process is defined such that performing the analysis based on the two or more information items on data stored on the storage server produces a same result as performing the analysis based on the two or more information items on data input in the device.

21. The program according to claim 20, further causing the computer to comprise a unit that sends a result of the analysis to a service server for providing the service to the user whose information identifying an individual as a user to be provided with the service is managed,
wherein the computer, not referring to the information identifying an individual but according to an ID issued to the user whose information is managed, manages data acquired from the storage server and a result of the analysis to be sent to the service server.

22. The program according to claim 20,
wherein data acquired from the storage server are data after an additional process has been performed, in addition to the process, by using an additional parameter of the user on part of data input in the device for the two or more information items, and
wherein the unit that performs the analysis comprises a unit that acquires the additional parameter from the user and performs a process reverse to the additional process on data acquired from the storage server.

23. A program for causing a computer, capable of being connected via a network to a system for continuously receiving from a user device and storing personal data of a user and providing the user with a service based on the data, to function as the device,
wherein the service is provided by using a result of an analysis based on two or more personal information items of the user, the program causing the computer to comprise:
a unit that holds a secret parameter of the user;
a unit that uses the secret parameter to process at least respective parts of that personal data of the user input for the two or more information items; and
a unit that sends the processed data to a server that performs the storing in the system,
wherein the process is defined such that performing the analysis based on the two or more information items on data stored on the server produces a same result as performing the analysis based on the two or more information items on data input in the device, whereby the analysis is performed in the system without the secret parameter being used.

24. The program according to claim 23, further causing the computer to comprise:
a unit that requests the server to send stored personal data of the user; and
a unit that restores the input data by using the secret parameter to perform a process reverse to the process on data sent in response to the request.

25. The program according to claim 23, further causing the computer to comprise:
a and that holds an additional parameter of the user;
a unit that uses the additional parameter to, in addition to or separately from the process, additionally process part of the personal data of the user input for the two or more information items, and allows the processed and additionally processed data to be data to be sent to the server; and
a unit that chooses a server to use the additional parameter to perform the analysis from among a plurality of servers in the system, and sends the additional parameter to the server.
